(19) United States
(12) Patent Application Publication
(10) Pub. No.: US 2024/0377570 A1
(43) Pub. Date: Nov. 14, 2024

(54) UV AND VISIBLE LIGHT EXIT GRATING FOR EYEPIECE FABRICATION AND OPERATION

(71) Applicant: Magic Leap, Inc., Plantation, FL (US)

(72) Inventors: BENJAMIN LAWRENCE VARGHESE, OAKLAND, CA (US); JOSEPH CHRISTOPHER SAWICKI, AUSTIN, TX (US)

(21) Appl. No.: 18/692,330

(22) PCT Filed: Sep. 15, 2022
(86) PCT No.: PCT/US2022/076504

§ 371 Date: Mar. 15, 2024

Related U.S. Application Data
(60) Provisional application No. 63/245,169, filed on Sep. 16, 2021.

(51) Int. Cl. F21V 8/00; G02B 27/01

(52) U.S. Cl. CPC G02B 6/0016; G02B 6/0036; G02B 6/0065; G02B 27/0172

(57) ABSTRACT

A method of forming a waveguide for an eyepiece for a display system to reduce optical degradation of the waveguide during segmentation is disclosed herein. The method includes providing a substrate having top and bottom major surfaces and a plurality of surface features, and using a laser beam to cut out a waveguide from said substrate by cutting along a path contacting and/or proximal to said plurality of surface features. The waveguide has edges formed by the laser beam and a main region and a peripheral region surrounding the main region. The peripheral region is surrounded by the edges.

### CROSS-REFERENCE TO RELATED APPLICATIONS

This application claims the benefit of U.S. Provisional Application No. 63/245,169, filed Sep. 16, 2021, the contents of which are incorporated by reference herein in their entirety.

### BACKGROUND

### Field

The present disclosure relates to optical elements such as waveguides for eyepieces that can be included in virtual reality and augmented reality imaging and visualization systems and methods of fabricating optical elements. Various waveguide designs, for example, are configured to redirect UV light laser light used to cut the waveguides from sheets of material to reduce the amount of such UV laser light that is coupled into the waveguide during fabrication that would otherwise degrade the optical quality of the waveguide.

### Description of the Related Art

Modern computing and display technologies have facilitated the development of systems for so called “virtual reality” or “augmented reality” experiences, wherein digitally reproduced images or portions thereof are presented to a user in a manner wherein they seem to be, or may be perceived as, real. A virtual reality, or “VR”, scenario typically involves presentation of digital or virtual image information without transparency to other actual real-world visual input; an augmented reality, or “AR”, scenario typically involves presentation of digital or virtual image information as an augmentation to visualization of the actual world around the user. An advanced augmented reality scenario can involve virtual objects that are integrated into, and responsive to, the natural world. For example, some AR content may be blocked by or otherwise be perceived as interacting with objects in the real world.

Referring to FIG. 1, an augmented reality scene 1 is depicted wherein a user of an AR technology sees a real-world park-like setting 6 featuring people, trees, buildings in the background, and a concrete platform 30. In addition to these items, the user of the AR technology also perceives that he “sees” “virtual content” such as a robot statue 10 standing upon the real-world platform 20, and a cartoon-like avatar character 2 flying by which seems to be a personification of a bumble bee, even though these elements 10 and 2 do not exist in the real world. Because the human visual perception system is complex, it is challenging to produce an AR technology that facilitates a comfortable, natural-feeling, rich presentation of virtual image elements amongst other virtual or real-world imagery elements.

Systems and methods disclosed herein address various challenges related to display technologies, including AR and VR technology. Some challenges in fabricating waveguides, for example, are addressed herein.

### SUMMARY

Methods of fabricating optical elements such as waveguides for eyepieces for AR and VR head mounted displays are disclosed. Some such optical elements (e.g., waveguides) are configured to include diffractive or diffraction grating(s), diffractive optical element(s) or other surface feature(s) that direct light that is coupled into the optical element (e.g., waveguides) out of the optical element/waveguide. In some examples, this light is UV light that is employed to singulate the optical element or waveguide from a sheet of material. A number of examples of waveguides, eyepieces, and display systems that include waveguides and/or eyepieces, as well as methods of forming the same are provided herein.

Example implementations described herein have several features, no single one of which is indispensable or solely responsible for their desirable attributes. A variety of example systems and methods are provided below.

Example 1: A display system configured to be disposed on a user's head and/or face so as to present images to a user's eye, said display system including:
at least one light source configured to produce light;
   an eyepiece configured to direct light from said light source to a user's eye to display image content therein, said eyepiece including:
      at least one waveguide having top and bottom major surfaces and an edge extending therebetween, said waveguide having a main region and a peripheral region surrounding said main region, said peripheral region more proximal to said edge than said main region, said waveguide configured to propagate light from said at least one light source between said top and bottom major surfaces by total internal reflection and eject at least some of said light out of at least a portion of said main region of said waveguide to said user's eye to present image content thereto, and a plurality of surface features within said peripheral region of said waveguide configured to couple light propagating in said waveguide out of said waveguide out from said peripheral region, said features including sloping surfaces, wherein surface features further from said edge have steeper sloping surfaces than surface features closer to said edge.

Example 2: The display system of Example 1, wherein the plurality of surface features includes a diffraction grating.

Example 3: The display system of Example 1, wherein the plurality of surface features includes a blazed grating.

Example 4: The display system of any of the examples above, wherein at least one of said surface features has at least one sloping surface.

Example 5: The display system of any of the examples above, wherein at least one of said surface features has two sloping surfaces.

Example 6: The display system of any of the examples above, wherein a plurality of said surface features have a sawtooth shape.

Example 7: The display system of any of the examples above, wherein a plurality of said surface features have a triangular cross-section orthogonal to the portion of the edge closest thereto.

Example 8: The display system of any of the examples above, wherein a plurality of said surface features are asymmetric.

Example 9: The display system of any of Claim 1, wherein a plurality of said surface features are symmetric.

Example 10: The display system of any of the examples above, wherein the plurality of surface features has an average height in a range from 10 to 500 nanometers (nm) high.

Example 11: The display system of any of the examples above, wherein the plurality of surface features has an average peak-to-peak spacing in a range from 100 and 500 nm.

Example 12: The display system of any of the examples above, wherein the plurality of surface features has an average full width at half maximum (FWHM) in a range from 75 and 250 nm.

Example 13: The display system of any of the examples above, wherein the plurality of surface features extends out, on one or both of the top and bottom major surfaces no more than 2 mm from the edge.

Example 14: The display system of any of the examples above, wherein the plurality of surface features extends out, on one or both of the top and bottom major surfaces no more than 1.8 mm from the edge.

Example 15: The display system of any of the examples above, wherein the plurality of surface features extends out, on one or both of the top and bottom major surfaces no more than 1.6 mm from the edge.

Example 16: The display system of any of the examples above, wherein the plurality of surface features extends to within 0.2 mm from said edge.

Example 17: The display system of any of the examples above, wherein the plurality of surface features extends to within 0.1 mm from said edge.

Example 18: The display system of any of the examples above, wherein the plurality of surface features extends to within 0.05 mm from said edge.

Example 19: The display system of any of the examples above, further including a light absorbing material disposed on the edge and one or more of the plurality of surface features.

Example 20: The display system of Example 19, wherein the light absorbing material covers an area beyond portions of the top and bottom major surfaces having the plurality of surface features.

Example 21: The display system of any of Examples 1-18, wherein said plurality of surface features are not covered by dark material.

Example 22: The display system of any of Examples 1-18 or 21, wherein said plurality of surface features are not covered by black or grey material.

Example 23: The display system of any of Examples 1-18, 21 or 22, wherein said plurality of surface features are not covered by opaque material.

Example 24: The display system of any of the examples above, wherein the waveguide is part of a stack of waveguides.

Example 25: The display system of any of the examples above, wherein the eyepiece is disposed on a frame configured to be supported on the head or face of the user.

Example 26: The display system of any of the examples above, wherein the eyepiece forms part of eyewear configured to be worn by the user.

Example 27: The display system of any of the examples above, wherein the eyepiece is transparent such that the user can see through the eyepiece to view the environment in front of the user and the eyepiece.

Example 28: A method of forming said display system of any of the examples above, including forming said eyepiece by using a laser beam to cut a waveguide from a sheet of material having said plurality of surface features formed therein.

Example 29: A method of forming said display system of the examples above, wherein said laser beam cuts along an edge of said plurality of surface features.

Example 30: A method of forming said display system of any of Examples 1-28, wherein said laser beam cuts along a path surrounded on both sides by said plurality of surface features.

Example 31: A method of forming said display system of any of the Examples 1-28, wherein said laser beam cuts along a path surrounding said plurality of surface features such that said plurality of surface features are disposed between said path and said main region.

Example 32: A display system configured to be disposed on a user's head and/or face so as to present images to a user's eye, said display system including:
at least one light source configured to produce light;
   an eyepiece configured to direct light from said light source to a user's eye to display image content therein, said eyepiece including:
      at least one waveguide having top and bottom major surfaces and an edge extending therebetween, said waveguide having a main region and a peripheral region surrounding said main region, said peripheral region more proximal to said edge than said main region, said waveguide configured to propagate light from said at least one light source between the top and bottom major surfaces by total internal reflection and eject at least some of said light out of at least a portion of said main region of said waveguide to said user's eye to present image content thereto, and a plurality of surface features within said peripheral region of said waveguide configured to couple light propagating in said waveguide out of said waveguide out from said peripheral region, wherein said features are not covered by light absorbing material.

Example 33: The display system of Example 32, wherein said surface features are not covered by dark material.

Example 34: The display system of Example 32 or 33, wherein said surface features are not covered by black or grey material.

Example 35: The display system of any of Examples 32-34, wherein said surface features are not covered by opaque material.

Example 36: A display system configured to be disposed on a user's head and/or face so as to present images to a user's eye, said display system including:
at least one light source configured to produce light;
an eyepiece configured to direct light from said light source to a user's eye to display image content therein, said eyepiece including:
   at least one waveguide having top and bottom major surfaces and an edge extending therebetween, said waveguide having a main region and a peripheral region surrounding said main region, said peripheral region more proximal to said edge than said main region, said waveguide configured to propagate light from said at least one light source between the top and bottom major surfaces by total internal reflection and eject at least some of said light out of at least a portion of said main region of said waveguide to said user's eye to present image content thereto, and a plurality of surface features within said peripheral region of said waveguide
   (i) configured to couple light propagating in said waveguide from said main region toward said peripheral region out of said waveguide out from said peripheral region, and
   (ii) configured to couple light propagating in said waveguide from said edge toward said main region out of said waveguide out from said peripheral region.

Example 37: The display system of Example 36, wherein at least one of said plurality of surface features within said peripheral region of said waveguide is (i) configured to couple light propagating in said waveguide from said main region toward said peripheral region out of said waveguide out from said peripheral region and (ii) configured to couple light propagating in said waveguide from said edge toward said main region out of said waveguide out from said peripheral region.

Example 38: The display system of Example 36 or 37, wherein surface features further from said edge have steeper sloping surfaces that surface features closer to said edge

Example 39: A display system configured to be disposed on a user's head and/or face so as to present images to a user's eye, said display system including:
at least one light source configured to produce light;
   an eyepiece configured to direct light from said light source to a user's eye to display image content therein, said eyepiece including:
      at least one waveguide having top and bottom major surfaces and an edge extending therebetween, said waveguide having a main region and a peripheral region surrounding said main region, said peripheral region more proximal to said edge than said main region, said waveguide configured to propagate light from said at least one light source between the top and bottom major surfaces by total internal reflection and eject at least some of said light out of at least a portion of said main region of said waveguide to said user's eye to present image content thereto, and at least one surface feature within said peripheral region of said waveguide (i) configured to couple light propagating in said waveguide from said main region toward said peripheral region out of said waveguide out from said peripheral region and (ii) configured to couple light propagating in said waveguide from said edge toward said main region out of said waveguide out from said peripheral region.

Example 40: A display system configured to be disposed on a user's head and/or face so as to present images to a user's eye, said display system including:
at least one light source configured to produce light;
   an eyepiece configured to direct light from said light source to a user's eye to display image content therein, said eyepiece including:
      at least one waveguide having top and bottom major surfaces and an edge extending therebetween, said waveguide having a main region and a peripheral region surrounding said main region, said peripheral region more proximal to said edge than said main region, said waveguide configured to propagate light from said at least one light source between the top and bottom major surfaces by total internal reflection and eject at least some of said light out of at least a portion of said main region of said waveguide to said user's eye to present image content thereto, and a first plurality of surface features on said top major surface within said peripheral region of said waveguide and a second plurality of surface features on said bottom major surface within said peripheral region of said waveguide, said first and second pluralities of surface features configured to couple light propagating in said waveguide out of said waveguide out from said top and bottom major surfaces in said peripheral region, respectively, said first plurality of surface features, said second plurality of surface features, or both including sloping surfaces.

Example 41: The display system of Example 40, wherein said second plurality of surface features have a cross-sectional shape that is a mirror image of that of said first plurality of surface features.

Example 42: The display system of Example 40 or 41, wherein surface features further from said edge in said first plurality of surface features have steeper sloping surfaces than surface features in said first plurality of surface features closer to said edge.

Example 43: The display system of any of Examples 40-42, wherein surface features further from said edge in said second plurality of surface features have steeper sloping surfaces than surface features in said second plurality of surface features closer to said edge.

Example 44: The display system of any of Examples 40-43, wherein said first and second plurality of surface features have a sawtooth shape.

Example 45: The display system of any of Examples 40-44, wherein said first and second plurality of surface features have a triangular cross-section orthogonal to said portion of said edge closest thereto.

Example 46: The display system of any of Examples 40-45, wherein said first plurality of surface features slope more in a first direction and said second plurality of surface features slope more in a second direction different from the first direction.

Example 47: The display system of any of Examples 40-46, wherein said first plurality of surface features are asymmetric.

Example 48: The display system of any of Examples 40-47, wherein said second plurality of surface features are asymmetric.

Example 49: A method of forming a waveguide for an eyepiece for a display system, said method including:
providing a substrate having top and bottom major surfaces and a plurality of surface features; and using a laser beam to cut out a waveguide from said substrate by cutting along a path contacting and/or proximal to said plurality of surface features, said waveguide having edges formed by said laser beam and a main region and a peripheral region surrounding said main region, said peripheral region surrounded by said edges.

Example 50: The method of Example 49, further including forming said plurality of surface features in said substrate.

Example 51: The method of Example 49, further including forming said plurality of surface features in said substrate using nano-imprinting.

Example 52: The method of any of Examples 49-51, wherein the plurality of surface features is configured such that at least some of said laser light that is coupled into said waveguide is directed out of said waveguide by said plurality of surface features.

Example 53: The method of any of Examples 49-52, wherein the plurality of surface features includes a diffraction grating.

Example 54: The method of any of Examples 49-53, wherein the plurality of surface features includes a blazed grating.

Example 55: The method of any of Examples 49-54, wherein a plurality of said surface features have at least one sloping surface.

Example 56: The method of any of Examples 49-55, wherein a plurality of said surface features have two sloping surfaces.

Example 57: The method of any of Examples 49-56, wherein a plurality of said surface features have a sawtooth shape.

Example 58: The method of any of Examples 49-57, wherein a plurality of said surface features have a triangular cross-section.

Example 59: The method of any of Examples 49-58, wherein a plurality of surface features are asymmetric.

Example 60: The method of any of the Examples 49-58, wherein a plurality of surface features are symmetric.

Example 61: The method of any of Examples 49-60, wherein the plurality of surface features have a height in a range from 10 to 500 nanometers (nm) high.

Example 62: The method of any of the Examples 49-61, wherein the plurality of surface features have an average peak-to-peak spacing in a range from 100 to 500.

Example 63: The method of any of the Examples 49-62, wherein the plurality of surface features have a full width at half maximum (FWHM) in a range from 75 to 250 nm.

Example 64: The method of any of the Examples 49-63, wherein the substrate is cut by the laser such that the plurality of surface features extends out, on one or both of the top and bottom major surfaces no more than 2 mm from the path cut by the laser.

Example 65: The method of any of the Examples 49-64, wherein the substrate is cut by the laser such that the plurality of surface features extends out, on one or both of the top and bottom major surfaces no more than 1.8 mm from the path cut by the laser.

Example 66: The method of any of the Examples 49-65, wherein the substrate is cut by the laser such that the plurality of surface features extends out, on one or both of the top and bottom major surfaces no more than 1.6 mm from the path cut by the laser.

Example 67: The method of any of the Examples 49-66, wherein the substrate is cut by the laser such that the plurality of surface features extends to at least within 0.2 mm from said path cut by the laser.

Example 68: The method of any of the Examples 49-67, wherein the substrate is cut by the laser such that the plurality of surface features extends to at least within 0.1 mm from said path cut by the laser.

Example 69: The method of any of the Examples 49-68, wherein the substrate is cut by the laser such that the plurality of surface features extends to at least within 0.05 mm from said path cut by the laser.

Example 70: The method of any of the Examples 49-69, further including depositing light absorbing material on the edge and one or more of plurality of surface features.

Example 71: The method of Example 70, further including covering an area beyond portions of the top and bottom major surfaces having the plurality of surface features with the light absorbing material.

Example 72: The method of any of the Examples 49-69, wherein said plurality of surface features are not covered by dark material.

Example 73: The method of any of the Examples 49-69, wherein said plurality of surface features are not covered by black or grey material.

Example 74: The method of any of the Examples 49-69, wherein said plurality of surface features are not covered by opaque material.

Example 75: The method of any of the Examples 49-74, wherein the waveguide is included as part of a stack of waveguides.

Example 76: The method of any of the Examples 49-75, wherein the eyepiece is disposed on a frame configured to be supported on the head or face of the user.

Example 77: The method of any of the Examples 49-76, wherein the eyepiece is included in eyewear configured to be worn by the user.

Example 78: The method of any of the Examples 49-77, wherein the eyepiece is transparent such that the user can see through the eyepiece to view the environment in front of the user and the eyepiece.

Example 79: The method of any of the Examples 49-78, wherein said laser beam cuts along an edge of said plurality of surface features.

Example 80: The method of forming said display system of any of the Examples 49-78, wherein said laser beam cuts along a path surrounded on both sides by a plurality of said surface features.

Example 81: The method of any of the Examples 49-78, wherein said laser beam cuts along a path surrounding said plurality of surface features such that said plurality of surface features are disposed between said path and said main region.

Example 82: The display system of any of Examples 32-35, 36-38, 39 or 40-48, wherein the plurality of surface features includes a diffraction grating.

Example 83: The display system of any of Examples 32-35, 36-38, 39 or 40-48, wherein the plurality of surface features includes a blazed grating.

Example 84: The display system of any of Examples 32-35, 36-38, 39, 4048, or 82-83, wherein at least one of said surface features has at least one sloping surface.

Example 85: The display system of any of Examples 32-35, 36-38, 39, 4048, or 82-84, wherein at least one of said surface features has two sloping surfaces.

Example 86: The display system of any of Examples 32-35, 36-38, 39, 4048, or 82-85, wherein a plurality of said surface features have a sawtooth shape.

Example 87: The display system of any of Examples 32-35, 36-38, 39, 4048, or 82-86, wherein a plurality of said surface features have a triangular cross-section orthogonal to the portion of the edge closest thereto.

Example 88: The display system of any of Examples 32-35, 36-38, 39, 4048, or 82-87, wherein a plurality of said surface features are asymmetric.

Example 89: The display system of any of Examples 32-35, 36-38, 39, 4048, or 82, wherein a plurality of said surface features are symmetric.

Example 90: The display system of any of Examples 32-35, 36-38, 39, 4048, or 82-89, wherein the surface features have an average height in a range from 10 to 500 nanometers (nm) high.

Example 91: The display system of any of Examples 32-35, 36-38, 39, 40-48, or 82-90, wherein the plurality of surface features have an average peak-to-peak spacing in a range from 100 and 500 nm.

Example 92: The display system of any of Examples 32-35, 36-38, 39, 40-48, or 82-91, wherein the plurality of surface features have an average full width at half maximum (FWHM) in a range from 75 and 250 nm.

Example 93: The display system of any of Examples 32-35, 36-38, 39, 40-48, or 82-92, wherein the plurality of surface features extends out, on one or both of the top and bottom major surfaces no more than 2 mm from the edge.

Example 94: The display system of any of Examples 32-35, 36-38, 39, 40-48, or 82-93, wherein the plurality of surface features extends out, on one or both of the top and bottom major surfaces no more than 1.8 mm from the edge.

Example 95: The display system of any of Examples 32-35, 36-38, 39, 40-48, or 82-94, wherein the plurality of surface features extends out, on one or both of the top and bottom major surfaces no more than 1.6 mm from the edge.

Example 96: The display system of any of Examples 32-35, 36-38, 39, 40-48, or 82-95, wherein the plurality of surface features extends to within 0.2 mm from said edge.

Example 97: The display system of any of Examples 32-35, 36-38, 39, 40-48, or 82-96, wherein the plurality of surface features extends to within 0.1 mm from said edge.

Example 98: The display system of any of Examples 32-35, 36-38, 39, 4048, or 82-97, wherein the plurality of surface features extends to within 0.05 mm from said edge.

Example 99: The display system of any of Examples 36-38, 39, 40-48, or 82-98, further including a light absorbing material disposed on the edge and one or more of the plurality of surface features.

Example 100: The display system of Example 99, wherein the light absorbing material covers an area beyond portions of the top and bottom major surfaces having the plurality of surface features.

Example 101: The display system of any of Examples 32-35, 36-38, 39, 40-48, or 82-98, wherein said plurality of surface features are not covered by dark material.

Example 102: The display system of any of Examples 32-35, 36-38, 39, 40-48, 82-98 or 101, wherein said plurality of surface features are not covered by black or grey material.

Example 103: The display system of any of Examples 32-35, 36-38, 39, 40-48, 82-98, 101 or 102, wherein said plurality of surface features are not covered by opaque material.

Example 104: The display system of any of Examples 32-35, 36-38, 39, 40-48, or 82-103, wherein the waveguide is part of a stack of waveguides.

Example 105: The display system of any of Examples 32-35, 36-38, 39, 40-48, or 82-104, wherein the eyepiece is disposed on a frame configured to be supported on the head or face of the user.

Example 106: The display system of any of Examples 32-35, 36-38, 39, 40-48, or 82-105, wherein the eyepiece forms part of eyewear configured to be worn by the user.

Example 107: The display system of any of Examples 32-35, 36-38, 39, 40-48, or 82-106, wherein the eyepiece is transparent such that the user can see through the eyepiece to view the environment in front of the user and the eyepiece.

Example 108: The method of forming said display system of any of Examples 32-35, 36-38, 39, 40-48, or 82-107, including forming said eyepiece by using a laser beam to cut a waveguide from a sheet of material having said plurality of surface features formed therein.

Example 109: The method of forming said display system of Examples 32-35, 36-38, 39, 40-48, or 82-108, wherein said laser beam cuts along an edge of said plurality of surface features.

Example 110: The method of forming said display system of any of Examples 32-35, 36-38, 39, 40-48, or 82-108, wherein said laser beam cuts along a path surrounded on both sides by said plurality of surface features.

Example 111: The method of forming said display system of any of Examples 32-35, 36-38, 39, 40-48, or 82-108, wherein said laser beam cuts along a path surrounding said plurality of surface features such that said plurality of surface features are disposed between said path and said main region.

These and other features will now be described with reference to the drawings summarized above. The drawings and the associated descriptions are provided to illustrate implementations and not to limit the scope of the disclosure or claims. Throughout the drawings, reference numbers may be reused to indicate correspondence between referenced elements. In addition, where applicable, the first one or two digits of a reference numeral for an element can frequently indicate the figure number in which the element first appears.

### BRIEF DESCRIPTION OF THE DRAWINGS

FIG. 1 illustrates a user's view of augmented reality (AR) through an AR device.

FIG. 2 illustrates an example of a wearable display system.

FIG. 3 illustrates a conventional display system for simulating three-dimensional imagery for a user.

FIG. 4 illustrates aspects of an approach for simulating three-dimensional imagery using multiple depth planes.

FIGS. 5A-5C illustrate relationships between radius of curvature and focal radius.

FIG. 6 illustrates an example of a waveguide stack for outputting image information to a user.

FIGS. 7A and 7B illustrate an example of exit beams outputted by a waveguide.

FIG. 8 illustrates an example of a stacked waveguide assembly in which each depth plane includes images formed using multiple different component colors.

FIG. 9A illustrates a cross-sectional side view of an example of a set of stacked waveguides that each includes an in-coupling optical element.

FIG. 9B illustrates a perspective view of an example of the plurality of stacked waveguides of FIG. 9A.

FIG. 9C illustrates a top-down plan view of an example of the plurality of stacked waveguides of FIGS. 9A and 9B.

FIG. 10 illustrates an example waveguide for an eyepiece for presenting virtual image content to a user's eye wherein said waveguide includes a diffraction grating along the periphery of the waveguide.

FIG. 11 illustrates a close-up of the diffraction grating located in a peripheral region of the waveguide.

FIG. 12 is a close-up perspective view depicting the plurality of surface features forming the diffraction grating.

FIG. 13 is a side cross-sectional view of a plurality of surface features in the peripheral region of a waveguide configured to facilitate egress of light coupled into the edge of the waveguide during the singulation process where UV laser light is used to cut the waveguide from a sheet of material.

FIGS. 14A-14C illustrate a plurality of waveguides having surface features in a peripheral region of the waveguide that are configured for egress of light coupled into an edge of the waveguide at different angles, namely, 45°, 60°, and 70°.

FIG. 14D illustrate a plurality of waveguides having surface features in a peripheral region of the waveguide and light coupled into an edge of the waveguide at an angle, e.g., 80° that misses said surface features.

FIG. 14E illustrates a waveguide having surface features in a peripheral region of the waveguide wherein the surface features have different shapes to facilitate egress of light coupled into an edge of the waveguide at a plurality of different angles, e.g., 45°, 60°, and 70°.

FIG. 15 is a close-up of FIG. 14E.

FIG. 16 is a block diagram illustrating an example method of singulating an optical element such as a waveguide from a sheet of material using a laser.

FIG. 17 illustrates a waveguide having surface features in a peripheral region of the waveguide to facilitate egress of light containing image content that is not coupled out of the waveguide to the eye. The waveguide further includes an opaque coating to absorb light ejected from the waveguide by said surface features.

FIG. 18 illustrates a waveguide having surface features in a peripheral region of the waveguide configured to facilitate egress of light coupled into the edge of the waveguide during the singulation process where UV laser light is used to cut the waveguide from a sheet of material as well as to facilitate egress of light containing image content that is not coupled out of the waveguide to the eye.

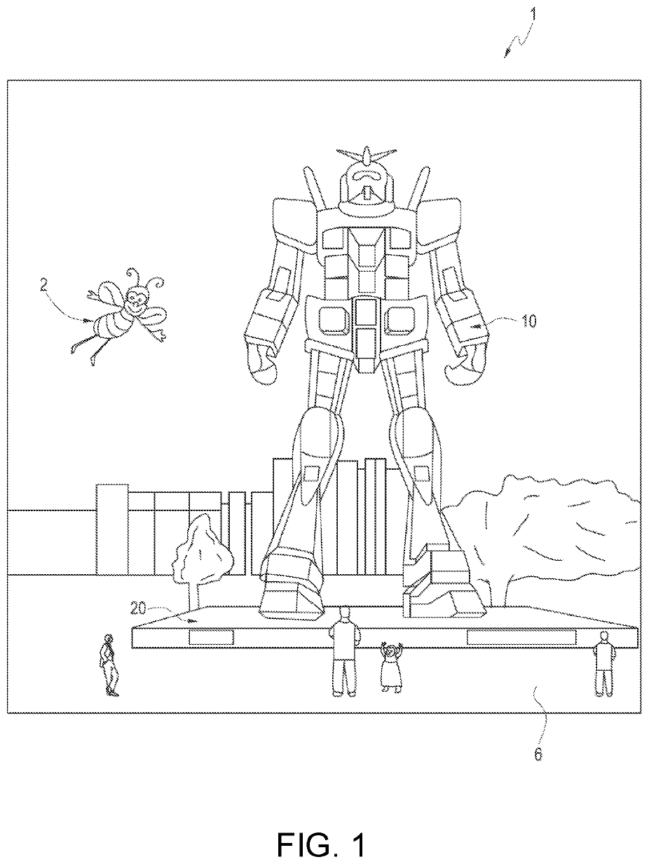

Like reference numbers and designations in the various drawings indicate like elements throughout.

### DETAILED DESCRIPTION

### Example Display Systems

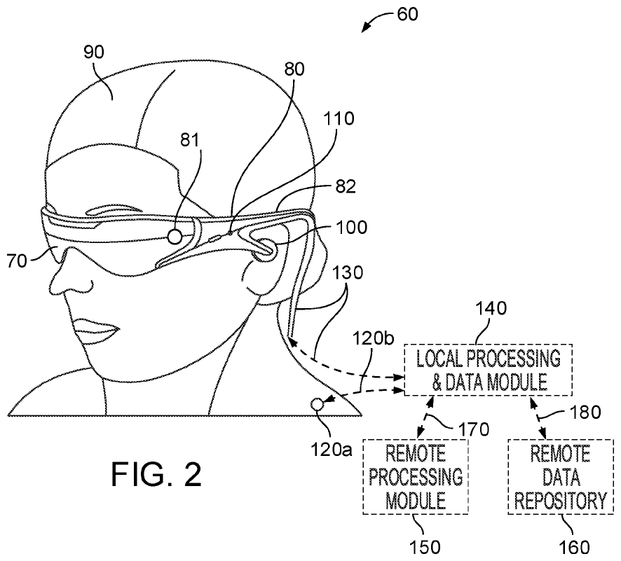

FIG. 2 illustrates an example of wearable display system 60. The display system 60 includes a display 70, and various mechanical and electronic modules and systems to support the functioning of that display 70. The display 70 may be coupled to a frame 80, which is wearable by a display system user or viewer 90 and which is configured to position the display 70 in front of the eyes of the user 90. The display 70 may be considered eyewear in some implementations. In some implementations, a speaker 100 is coupled to the frame 80 and configured to be positioned adjacent the ear canal of the user 90 (in some implementations, another speaker, not shown, is positioned adjacent the other ear canal of the user to provide stereo/shapeable sound control). In some implementations, the display system may also include one or more microphones 110 or other devices to detect sound. In some implementations, the microphone is configured to allow the user to provide inputs or commands to the system 60 (e.g., the selection of voice menu commands, natural language questions, etc.), and/or may allow audio communication with other persons (e.g., with other users of similar display systems. The microphone may further be configured as a peripheral sensor to collect audio data (e.g., sounds from the user and/or environment). In some implementations, the display system may also include a peripheral sensor 120a, which may be separate from the frame 80 and attached to the body of the user 90 (e.g., on the head, torso, an extremity, etc. of the user 90). The peripheral sensor 120a may be configured to acquire data characterizing the physiological state of the user 90 in some implementations. For example, the sensor 120a may be an electrode.

With continued reference to FIG. 2, the display 70 is operatively coupled by communications link 130, such as by a wired lead or wireless connectivity, to a local data processing module 140 which may be mounted in a variety of configurations, such as fixedly attached to the frame 80, fixedly attached to a helmet or hat worn by the user, embedded in headphones, or otherwise removably attached to the user 90 (e.g., in a backpack-style configuration, in a belt-coupling style configuration). Similarly, the sensor 120a may be operatively coupled by communications link 120b, e.g., a wired lead or wireless connectivity, to the local processor and data module 140. The local processing and data module 140 may include a hardware processor, as well as digital memory, such as non-volatile memory (e.g., flash memory or hard disk drives), both of which may be utilized to assist in the processing, caching, and storage of data. The data include data a) captured from sensors (which may be, e.g., operatively coupled to the frame 80 or otherwise attached to the user 90), such as image capture devices (such as cameras), microphones, inertial measurement units, accelerometers, compasses, GPS units, radio devices, gyros, and/or other sensors disclosed herein; and/or b) acquired and/or processed using remote processing module 150 and/or remote data repository 160 (including data relating to virtual content), possibly for passage to the display 70 after such processing or retrieval. The local processing and data module 140 may be operatively coupled by communication links 170, 180, such as via a wired or wireless communication links, to the remote processing module 150 and remote data repository 160 such that these remote modules 150, 160 are operatively coupled to each other and available as resources to the local processing and data module 140. In some implementations, the local processing and data module 140 may include one or more of the image capture devices, microphones, inertial measurement units, accelerometers, compasses, GPS units, radio devices, and/or gyros. In some other implementations, one or more of these sensors may be attached to the frame 80, or may be standalone structures that communicate with the local processing and data module 140 by wired or wireless communication pathways.

With continued reference to FIG. 2, in some implementations, the remote processing module 150 may include one or more processors configured to analyze and process data and/or image information. In some implementations, the remote data repository 160 may include a digital data storage facility, which may be available through the internet or other networking configuration in a “cloud” resource configuration. In some implementations, the remote data repository 160 may include one or more remote servers, which provide information, e.g., information for generating augmented reality content, to the local processing and data module 140 and/or the remote processing module 150. In some implementations, all data is stored and all computations are performed in the local processing and data module, allowing fully autonomous use from a remote module.

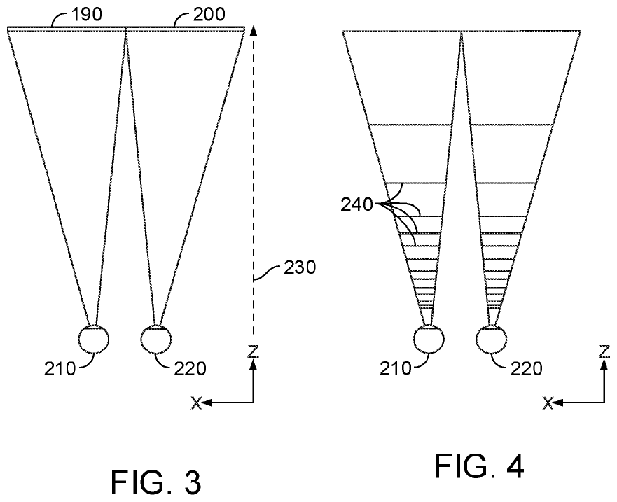

The perception of an image as being “three-dimensional” or “3-D” may be achieved by providing slightly different presentations of the image to each eye of the viewer. FIG. 3 illustrates a conventional display system for simulating three-dimensional imagery for a user. Two distinct images 190, 200—one for each eye 210, 220—are outputted to the user. The images 190, 200 are spaced from the eyes 210, 220 by a distance 230 along an optical or z-axis that is parallel to the line of sight of the viewer. The images 190, 200 are flat and the eyes 210, 220 may focus on the images by assuming a single accommodated state. Such 3-D display systems rely on the human visual system to combine the images 190, 200 to provide a perception of depth and/or scale for the combined image.

It will be appreciated, however, that the human visual system is more complicated and providing a realistic perception of depth is more challenging. For example, many viewers of conventional “3-D” display systems find such systems to be uncomfortable or may not perceive a sense of depth at all. Without being limited by theory, it is believed that viewers of an object may perceive the object as being “three-dimensional” due to a combination of vergence and accommodation. Vergence movements (i.e., rotation of the eyes so that the pupils move toward or away from each other to converge the lines of sight of the eyes to fixate upon an object) of the two eyes relative to each other are closely associated with focusing (or “accommodation”) of the lenses and pupils of the eyes. Under normal conditions, changing the focus of the lenses of the eyes, or accommodating the eyes, to change focus from one object to another object at a different distance will automatically cause a matching change in vergence to the same distance, under a relationship known as the “accommodation-vergence reflex,” as well as pupil dilation or constriction. Likewise, a change in vergence will trigger a matching change in accommodation of lens shape and pupil size, under normal conditions. As noted herein, many stereoscopic or “3-D” display systems display a scene using slightly different presentations (and, so, slightly different images) to each eye such that a three-dimensional perspective is perceived by the human visual system. Such systems are uncomfortable for many viewers, however, since they, among other things, simply provide a different presentation of a scene, but with the eyes viewing all the image information at a single accommodated state, and work against the “accommodation-vergence reflex.” Display systems that provide a better match between accommodation and vergence may form more realistic and comfortable simulations of three-dimensional imagery contributing to increased duration of wear and in turn compliance to diagnostic and therapy protocols.

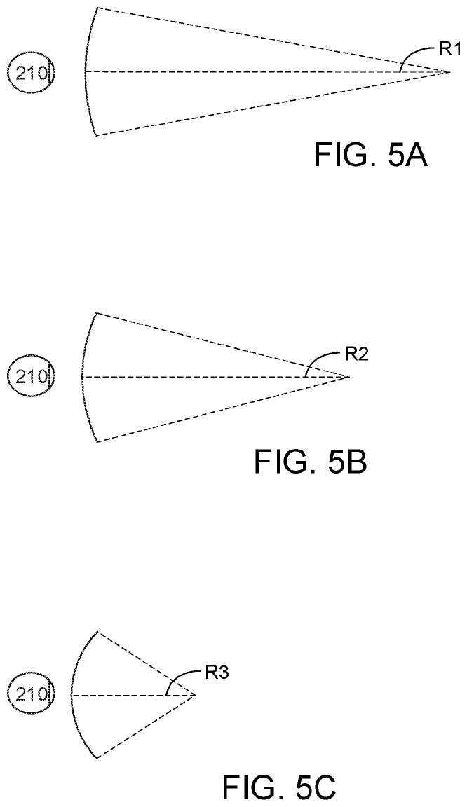

FIG. 4 illustrates aspects of an approach for simulating three-dimensional imagery using multiple depth planes. With reference to FIG. 4, objects at various distances from eyes 210, 220 on the z-axis are accommodated by the eyes 210, 220 so that those objects are in focus. The eyes 210, 220 assume particular accommodated states to bring into focus objects at different distances along the z-axis. Consequently, a particular accommodated state may be said to be associated with a particular one of depth planes 240, with has an associated focal distance, such that objects or parts of objects in a particular depth plane are in focus when the eye is in the accommodated state for that depth plane. In some implementations, three-dimensional imagery may be simulated by providing different presentations of an image for each of the eyes 210, 220, and also by providing different presentations of the image corresponding to each of the depth planes. While shown as being separate for clarity of illustration, it will be appreciated that the fields of view of the eyes 210, 220 may overlap, for example, as distance along the z-axis increases. In addition, while shown as flat for ease of illustration, it will be appreciated that the contours of a depth plane may be curved in physical space, such that all features in a depth plane are in focus with the eye in a particular accommodated state.

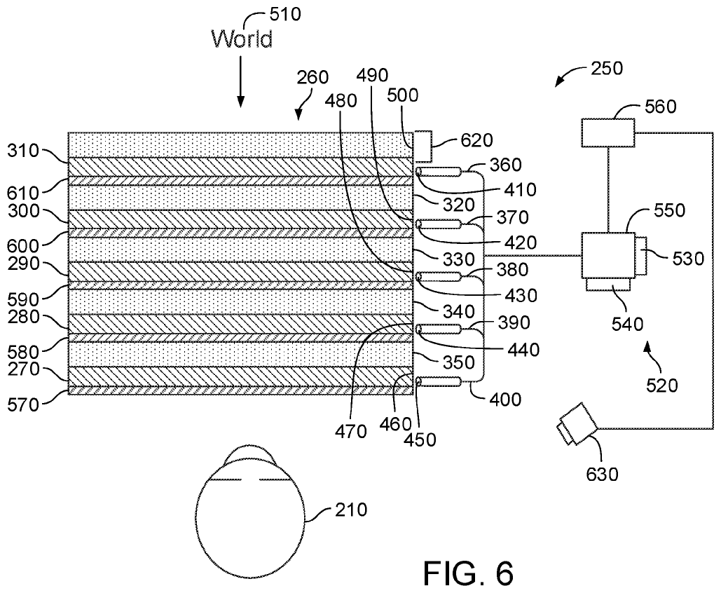

The distance between an object and the eye 210 or 220 may also change the amount of divergence of light from that object, as viewed by that eye. FIGS. 5A-5C illustrate relationships between distance and the divergence of light rays. The distance between the object and the eye 210 is represented by, in order of decreasing distance, R1, R2, and R3. As shown in FIGS. 5A-5C, the light rays become more divergent as distance to the object decreases. As distance increases, the light rays become more collimated. Stated another way, it may be said that the light field produced by a point (the object or a part of the object) has a spherical wavefront curvature, which is a function of how far away the point is from the eye of the user. The curvature increases with decreasing distance between the object and the eye 210. Consequently, at different depth planes, the degree of divergence of light rays is also different, with the degree of divergence increasing with decreasing distance between depth planes and the viewer's eye 210. While only a single eye 210 is illustrated for clarity of illustration in FIGS. 5A-5C and other figures herein, it will be appreciated that the discussions regarding eye 210 may be applied to both eyes 210 and 220 of a viewer.

Without being limited by theory, it is believed that the human eye typically can interpret a finite number of depth planes to provide depth perception. Consequently, a highly believable simulation of perceived depth may be achieved by providing, to the eye, different presentations of an image corresponding to each of these limited number of depth planes. The different presentations may be separately focused by the viewer's eyes, thereby helping to provide the user with depth cues based on the accommodation of the eye required to bring into focus different image features for the scene located on different depth plane and/or based on observing different image features on different depth planes being out of focus.

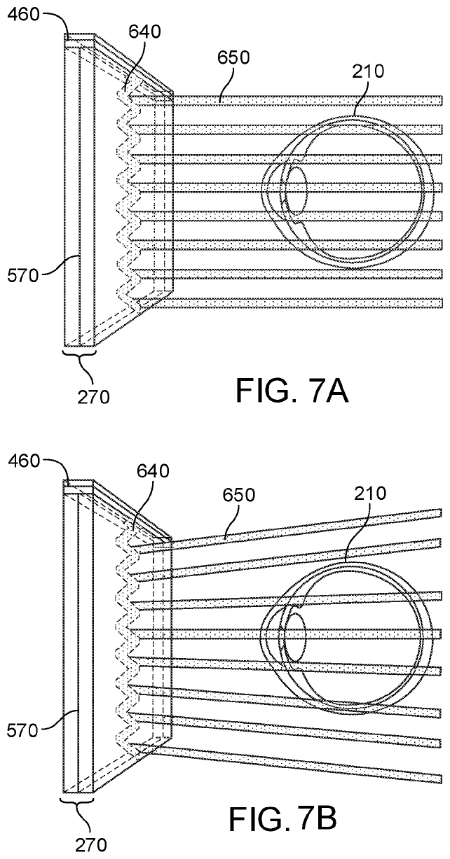

FIG. 6 illustrates an example of a waveguide stack for outputting image information to a user. A display system 250 includes a stack of waveguides, or stacked waveguide assembly, 260 that may be utilized to provide three-dimensional perception to the eye/brain using a plurality of waveguides 270, 280, 290, 300, 310. In some implementations, the display system 250 is the system 60 of FIG. 2, with FIG. 6 schematically showing some parts of that system 60 in greater detail. For example, the waveguide assembly 260 may be part of the display 70 of FIG. 2. It will be appreciated that the display system 250 may be considered a light field display in some implementations.

With continued reference to FIG. 6, the waveguide assembly 260 may also include a plurality of features 320, 330, 340, 350 between the waveguides. In some implementations, the features 320, 330, 340, 350 may be one or more lenses. The waveguides 270, 280, 290, 300, 310 and/or the plurality of lenses 320, 330, 340, 350 may be configured to send image information to the eye with various levels of wavefront curvature or light ray divergence. Each waveguide level may be associated with a particular depth plane and may be configured to output image information corresponding to that depth plane. Image injection devices 360, 370, 380, 390, 400 may function as a source of light for the waveguides and may be utilized to inject image information into the waveguides 270, 280, 290, 300, 310, each of which may be configured, as described herein, to distribute incoming light across each respective waveguide, for output toward the eye 210. Light exits an output surface 410, 420, 430, 440, 450 of the image injection devices 360, 370, 380, 390, 400 and is injected into a corresponding input surface 460, 470, 480, 490, 500 of the waveguides 270, 280, 290, 300, 310. In some implementations, the each of the input surfaces 460, 470, 480, 490, 500 may be an edge of a corresponding waveguide, or may be part of a major surface of the corresponding waveguide (that is, one of the waveguide surfaces directly facing the world 510 or the viewer's eye 210). In some implementations, a single beam of light (e.g. a collimated beam) may be injected into each waveguide to output an entire field of cloned collimated beams that are directed toward the eye 210 at particular angles (and amounts of divergence) corresponding to the depth plane associated with a particular waveguide. In some implementations, a single one of the image injection devices 360, 370, 380, 390, 400 may be associated with and inject light into a plurality (e.g., three) of the waveguides 270, 280, 290, 300, 310.

In some implementations, the image injection devices 360, 370, 380, 390, 400 are discrete displays that each produce image information for injection into a corresponding waveguide 270, 280, 290, 300, 310, respectively. In some other implementations, the image injection devices 360, 370, 380, 390, 400 are the output ends of a single multiplexed display which may, e.g., pipe image information via one or more optical conduits (such as fiber optic cables) to each of the image injection devices 360, 370, 380, 390, 400. It will be appreciated that the image information provided by the image injection devices 360, 370, 380, 390, 400 may include light of different wavelengths, or colors (e.g., different component colors, as discussed herein).

In some implementations, the light injected into the waveguides 270, 280, 290, 300, 310 is provided by a light projector system 520, which includes a light module 530, which may include a light emitter, such as a light emitting diode (LED). The light from the light module 530 may be directed to and modified by a light modulator 540, e.g., a spatial light modulator, via a beam splitter 550. The light modulator 540 may be configured to change the perceived intensity of the light injected into the waveguides 270, 280, 290, 300, 310. Examples of spatial light modulators include liquid crystal displays (LCD) including a liquid crystal on silicon (LCOS) displays.

In some implementations, the display system 250 may be a scanning fiber display including one or more scanning fibers configured to project light in various patterns (e.g., raster scan, spiral scan, Lissajous patterns, etc.) into one or more waveguides 270, 280, 290, 300, 310 and ultimately to the eye 210 of the viewer. In some implementations, the illustrated image injection devices 360, 370, 380, 390, 400 may schematically represent a single scanning fiber or a bundle of scanning fibers configured to inject light into one or a plurality of the waveguides 270, 280, 290, 300, 310. In some other implementations, the illustrated image injection devices 360, 370, 380, 390, 400 may schematically represent a plurality of scanning fibers or a plurality of bundles of scanning fibers, each of which are configured to inject light into an associated one of the waveguides 270, 280, 290, 300, 310. It will be appreciated that one or more optical fibers may be configured to transmit light from the light module 530 to the one or more waveguides 270, 280, 290, 300, 310. It will be appreciated that one or more intervening optical structures may be provided between the scanning fiber, or fibers, and the one or more waveguides 270, 280, 290, 300, 310 to, e.g., redirect light exiting the scanning fiber into the one or more waveguides 270, 280, 290, 300, 310.

A controller 560 controls the operation of one or more of the stacked waveguide assembly 260, including operation of the image injection devices 360, 370, 380, 390, 400, the light source 530, and the light modulator 540. In some implementations, the controller 560 is part of the local data processing module 140. The controller 560 includes programming (e.g., instructions in a non-transitory medium) that regulates the timing and provision of image information to the waveguides 270, 280, 290, 300, 310 according to, e.g., any of the various schemes disclosed herein. In some implementations, the controller may be a single integral device, or a distributed system connected by wired or wireless communication channels. The controller 560 may be part of the processing modules 140 or 150 (FIG. 2) in some implementations.

With continued reference to FIG. 6, the waveguides 270, 280, 290, 300, 310 may be configured to propagate light within each respective waveguide by total internal reflection (TIR). The waveguides 270, 280, 290, 300, 310 may each be planar or have another shape (e.g., curved), with major top and bottom surfaces and edges extending between those major top and bottom surfaces. In the illustrated configuration, the waveguides 270, 280, 290, 300, 310 may each include out-coupling optical elements 570, 580, 590, 600, 610 that are configured to extract light out of a waveguide by redirecting the light, propagating within each respective waveguide, out of the waveguide to output image information to the eye 210. Extracted light may also be referred to as out-coupled light and the out-coupling optical elements light may also be referred to light extracting optical elements. An extracted beam of light may be outputted by the waveguide at locations at which the light propagating in the waveguide strikes a light extracting optical element. The out-coupling optical elements 570, 580, 590, 600, 610 may, for example, be gratings, including diffractive optical features, as discussed further herein. While illustrated disposed at the bottom major surfaces of the waveguides 270, 280, 290, 300, 310, for ease of description and drawing clarity, in some implementations, the out-coupling optical elements 570, 580, 590, 600, 610 may be disposed at the top and/or bottom major surfaces, and/or may be disposed directly in the volume of the waveguides 270, 280, 290, 300, 310, as discussed further herein. In some implementations, the out-coupling optical elements 570, 580, 590, 600, 610 may be formed in a layer of material that is attached to a transparent substrate to form the waveguides 270, 280, 290, 300, 310. In some other implementations, the waveguides 270, 280, 290, 300, 310 may be a monolithic piece of material and the out-coupling optical elements 570, 580, 590, 600, 610 may be formed on a surface and/or in the interior of that piece of material.

With continued reference to FIG. 6, as discussed herein, each waveguide 270, 280, 290, 300, 310 is configured to output light to form an image corresponding to a particular depth plane. For example, the waveguide 270 nearest the eye may be configured to deliver collimated light (which was injected into such waveguide 270), to the eye 210. The collimated light may be representative of the optical infinity focal plane. The next waveguide up 280 may be configured to send out collimated light which passes through the first lens 350 (e.g., a negative lens) before it can reach the eye 210; such first lens 350 may be configured to create a slight convex wavefront curvature so that the eye/brain interprets light coming from that next waveguide up 280 as coming from a first focal plane closer inward toward the eye 210 from optical infinity. Similarly, the third up waveguide 290 passes its output light through both the first 350 and second 340 lenses before reaching the eye 210; the combined optical power of the first 350 and second 340 lenses may be configured to create another incremental amount of wavefront curvature so that the eye/brain interprets light coming from the third waveguide 290 as coming from a second focal plane that is even closer inward toward the person from optical infinity than was light from the next waveguide up 280.

The other waveguide layers 300, 310 and lenses 330, 320 are similarly configured, with the highest waveguide 310 in the stack sending its output through all of the lenses between it and the eye for an aggregate focal power representative of the closest focal plane to the person. To compensate for the stack of lenses 320, 330, 340, 350 when viewing/interpreting light coming from the world 510 on the other side of the stacked waveguide assembly 260, a compensating lens layer 620 may be disposed at the top of the stack to compensate for the aggregate power of the lens stack 320, 330, 340, 350 below. Such a configuration provides as many perceived focal planes as there are available waveguide/lens pairings. Both the out-coupling optical elements of the waveguides and the focusing aspects of the lenses may be static (i.e., not dynamic or electro-active). In some alternative implementations, either or both may be dynamic using electro-active features.

In some implementations, two or more of the waveguides 270, 280, 290, 300, 310 may have the same associated depth plane. For example, multiple waveguides 270, 280, 290, 300, 310 may be configured to output images set to the same depth plane, or multiple subsets of the waveguides 270, 280, 290, 300, 310 may be configured to output images set to the same plurality of depth planes, with one set for each depth plane. This can provide advantages for forming a tiled image to provide an expanded field of view at those depth planes.

With continued reference to FIG. 6, the out-coupling optical elements 570, 580, 590, 600, 610 may be configured to both redirect light out of their respective waveguides and to output this light with the appropriate amount of divergence or collimation for a particular depth plane associated with the waveguide. As a result, waveguides having different associated depth planes may have different configurations of out-coupling optical elements 570, 580, 590, 600, 610, which output light with a different amount of divergence depending on the associated depth plane. In some implementations, the light extracting optical elements 570, 580, 590, 600, 610 may be volumetric or surface features, which may be configured to output light at specific angles. For example, the light extracting optical elements 570, 580, 590, 600, 610 may be volume holograms, surface holograms, and/or diffraction gratings. In some implementations, the features 320, 330, 340, 350 may not be lenses; rather, they may simply be spacers (e.g., cladding layers and/or structures for forming air gaps).

In some implementations, the out-coupling optical elements 570, 580, 590, 600, 610 are diffractive features that form a diffraction pattern, or “diffractive optical element” (also referred to herein as a “DOE”). Preferably, the DOE's have a sufficiently low diffraction efficiency so that only a portion of the light of the beam is deflected away toward the eye 210 with each intersection of the DOE, while the rest continues to move through a waveguide via TIR. The light carrying the image information is thus divided into a number of related exit beams that exit the waveguide at a multiplicity of locations and the result is a fairly uniform pattern of exit emission toward the eye 210 for this particular collimated beam bouncing around within a waveguide.

In some implementations, one or more DOEs may be switchable between “on” states in which they actively diffract, and “off” states in which they do not significantly diffract. For instance, a switchable DOE may include a layer of polymer dispersed liquid crystal, in which microdroplets include a diffraction pattern in a host medium, and the refractive index of the microdroplets may be switched to substantially match the refractive index of the host material (in which case the pattern does not appreciably diffract incident light) or the microdroplet may be switched to an index that does not match that of the host medium (in which case the pattern actively diffracts incident light).

In some implementations, a camera assembly 630 (e.g., a digital camera, including visible light and infrared light cameras) may be provided to capture images of the eye 210 and/or tissue around the eye 210 to, e.g., detect user inputs and/or to monitor the physiological state of the user. As used herein, a camera may be any image capture device. In some implementations, the camera assembly 630 may include an image capture device and a light source to project light (e.g., infrared light) to the eye, which may then be reflected by the eye and detected by the image capture device. In some implementations, the camera assembly 630 may be attached to the frame 80 (FIG. 2) and may be in electrical communication with the processing modules 140 and/or 150, which may process image information from the camera assembly 630 to make various determinations regarding, e.g., the physiological state of the user, as discussed herein. It will be appreciated that information regarding the physiological state of user may be used to determine the behavioral or emotional state of the user. Examples of such information include movements of the user and/or facial expressions of the user. The behavioral or emotional state of the user may then be triangulated with collected environmental and/or virtual content data so as to determine relationships between the behavioral or emotional state, physiological state, and environmental or virtual content data. In some implementations, one camera assembly 630 may be utilized for each eye, to separately monitor each eye.

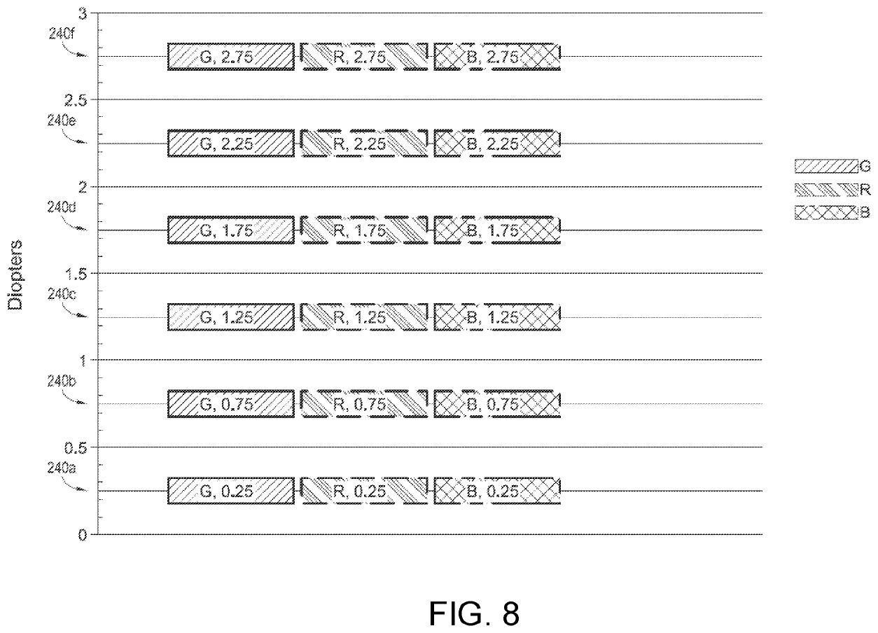

With reference now to FIGS. 7A-7B, examples of exit beams outputted by a waveguide are shown. One waveguide is illustrated, but it will be appreciated that other waveguides in the waveguide assembly 260 (FIG. 6) may function similarly, where the waveguide assembly 260 includes multiple waveguides. Light 640 is injected into the waveguide 270 at the input surface 460 of the waveguide 270 and propagates within the waveguide 270 by TIR. At points where the light 640 impinges on the DOE 570, a portion of the light exits the waveguide as exit beams 650. The exit beams 650 are illustrated in FIG. 7A as substantially parallel but they may also be redirected to propagate to the eye 210 at an angle (e.g., forming divergent exit beams) as illustrate in FIG. 7B, depending on the depth plane associated with the waveguide 270. It will be appreciated that substantially parallel exit beams may be indicative of a waveguide with out-coupling optical elements that out-couple light to form images that appear to be set on a depth plane at a large distance (e.g., optical infinity) from the eye 210. Other waveguides or other sets of out-coupling optical elements may output an exit beam pattern that is more divergent, which would require the eye 210 to accommodate to a closer distance to bring it into focus on the retina and would be interpreted by the brain as light from a distance closer to the eye 210 than optical infinity.

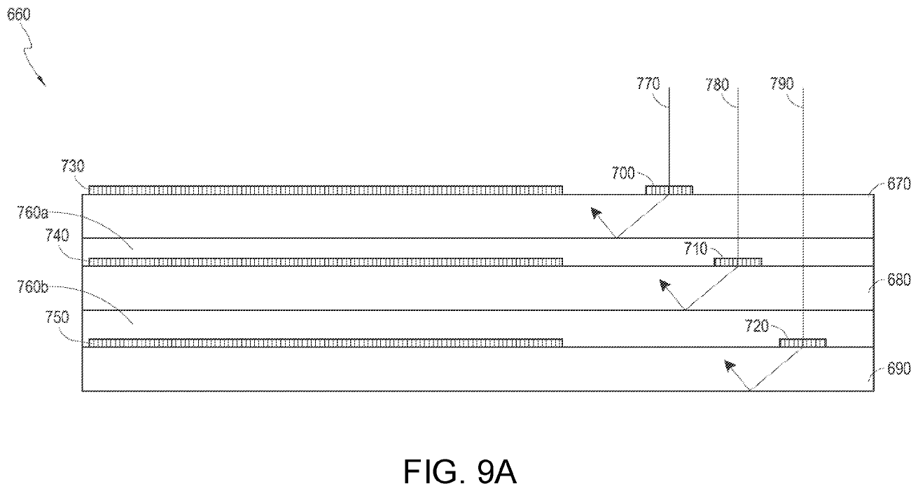

In some implementations, a full color image may be formed at each depth plane by overlaying images in each of the component colors, e.g., three or more component colors. FIG. 8 illustrates an example of a stacked waveguide assembly in which each depth plane includes images formed using multiple different component colors. The illustrated implementation shows depth planes 240a-240f, although more or fewer depths are also contemplated. Each depth plane may have three or more component color images associated with it, including: a first image of a first color, G; a second image of a second color, R; and a third image of a third color, B. Different depth planes are indicated in the figure by different numbers for diopters (dpt) following the letters G, R, and B. Just as examples, the numbers following each of these letters indicate diopters (1/m), or inverse distance of the depth plane from a viewer, and each box in the figures represents an individual component color image. In some implementations, to account for differences in the eye's focusing of light of different wavelengths, the exact placement of the depth planes for different component colors may vary. For example, different component color images for a given depth plane may be placed on depth planes corresponding to different distances from the user. Such an arrangement may increase visual acuity and user comfort and/or may decrease chromatic aberrations.

In some implementations, light of each component color may be outputted by a single dedicated waveguide and, consequently, each depth plane may have multiple waveguides associated with it. In such implementations, each box in the figures including the letters G, R, or B may be understood to represent an individual waveguide, and three waveguides may be provided per depth plane where three component color images are provided per depth plane. While the waveguides associated with each depth plane are shown adjacent to one another in this drawing for ease of description, it will be appreciated that, in a physical device, the waveguides may all be arranged in a stack with one waveguide per level. In some other implementations, multiple component colors may be outputted by the same waveguide, such that, e.g., only a single waveguide may be provided per depth plane.

With continued reference to FIG. 8, in some implementations, G is the color green, R is the color red, and B is the color blue. In some other implementations, other colors associated with other wavelengths of light, including magenta and cyan, may be used in addition to or may replace one or more of red, green, or blue.

It will be appreciated that references to a given color of light throughout this disclosure will be understood to encompass light of one or more wavelengths within a range of wavelengths of light that are perceived by a viewer as being of that given color. For example, red light may include light of one or more wavelengths in the range of about 620-780 nm, green light may include light of one or more wavelengths in the range of about 492-577 nm, and blue light may include light of one or more wavelengths in the range of about 435-493 nm.

In some implementations, the light source 530 (FIG. 6) may be configured to emit light of one or more wavelengths outside the visual perception range of the viewer, for example, infrared and/or ultraviolet wavelengths. In addition, the in-coupling, out-coupling, and other light redirecting structures of the waveguides of the display 250 may be configured to direct and emit this light out of the display towards the user's eye 210, e.g., for imaging and/or user stimulation applications.

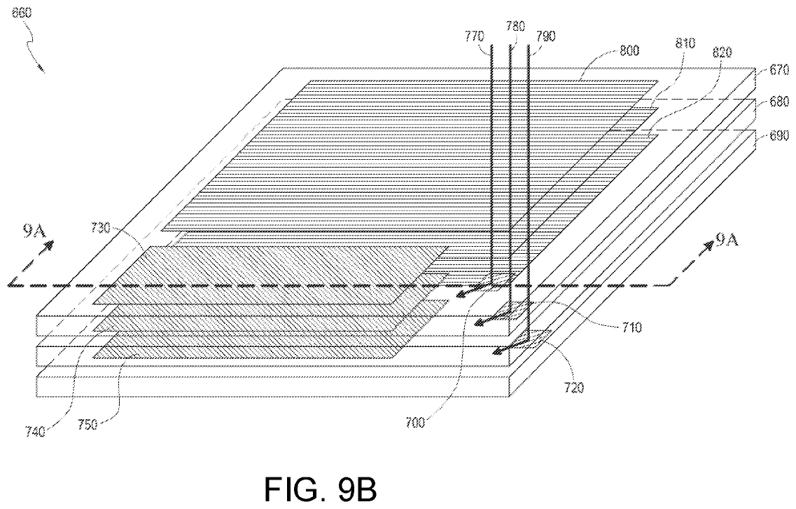

With reference now to FIG. 9A, in some implementations, light impinging on a waveguide may need to be redirected to in-couple that light into the waveguide. An in-coupling optical element may be used to redirect and in-couple the light into its corresponding waveguide. FIG. 9A illustrates a cross-sectional side view of an example of a plurality or set 660 of stacked waveguides that each includes an in-coupling optical element. The waveguides may each be configured to output light of one or more different wavelengths, or one or more different ranges of wavelengths. It will be appreciated that the stack 660 may correspond to the stack 260 (FIG. 6) and the illustrated waveguides of the stack 660 may correspond to part of the plurality of waveguides 270, 280, 290, 300, 310, except that light from one or more of the image injection devices 360, 370, 380, 390, 400 is injected into the waveguides from a position that requires light to be redirected for in-coupling.

The illustrated set 660 of stacked waveguides includes waveguides 670, 680, and 690. Each waveguide includes an associated in-coupling optical element (which may also be referred to as a light input area on the waveguide), with, e.g., in-coupling optical element 700 disposed on a major surface (e.g., an upper major surface) of waveguide 670, in-coupling optical element 710 disposed on a major surface (e.g., an upper major surface) of waveguide 680, and in-coupling optical element 720 disposed on a major surface (e.g., an upper major surface) of waveguide 690. In some implementations, one or more of the in-coupling optical elements 700, 710, 720 may be disposed on the bottom major surface of the respective waveguide 670, 680, 690 (particularly where the one or more in-coupling optical elements are reflective, deflecting optical elements). As illustrated, the in-coupling optical elements 700, 710, 720 may be disposed on the upper major surface of their respective waveguide 670, 680, 690 (or the top of the next lower waveguide), particularly where those in-coupling optical elements are transmissive, deflecting optical elements. In some implementations, the in-coupling optical elements 700, 710, 720 may be disposed in the body of the respective waveguide 670, 680, 690. In some implementations, as discussed herein, the in-coupling optical elements 700, 710, 720 are wavelength selective, such that they selectively redirect one or more wavelengths of light, while transmitting other wavelengths of light. While illustrated on one side or corner of their respective waveguide 670, 680, 690, it will be appreciated that the in-coupling optical elements 700, 710, 720 may be disposed in other areas of their respective waveguide 670, 680, 690 in some implementations.

As illustrated, the in-coupling optical elements 700, 710, 720 may be laterally offset from one another. In some implementations, each in-coupling optical element may be offset such that it receives light without that light passing through another in-coupling optical element. For example, each in-coupling optical element 700, 710, 720 may be configured to receive light from a different image injection device 360, 370, 380, 390, and 400 as shown in FIG. 6, and may be separated (e.g., laterally spaced apart) from other in-coupling optical elements 700, 710, 720 such that it substantially does not receive light from the other ones of the in-coupling optical elements 700, 710, 720.

Each waveguide also includes associated light distributing elements, with, e.g., light distributing elements 730 disposed on a major surface (e.g., a top major surface) of waveguide 670, light distributing elements 740 disposed on a major surface (e.g., a top major surface) of waveguide 680, and light distributing elements 750 disposed on a major surface (e.g., a top major surface) of waveguide 690. In some other implementations, the light distributing elements 730, 740, 750, may be disposed on a bottom major surface of associated waveguides 670, 680, 690, respectively. In some other implementations, the light distributing elements 730, 740, 750, may be disposed on both top and bottom major surface of associated waveguides 670, 680, 690, respectively; or the light distributing elements 730, 740, 750, may be disposed on different ones of the top and bottom major surfaces in different associated waveguides 670, 680, 690, respectively.

The waveguides 670, 680, 690 may be spaced apart and separated by, e.g., gas, liquid, and/or solid layers of material. For example, as illustrated, layer 760a may separate waveguides 670 and 680; and layer 760b may separate waveguides 680 and 690. In some implementations, the layers 760a and 760b are formed of low refractive index materials (that is, materials having a lower refractive index than the material forming the immediately adjacent one of waveguides 670, 680, 690). Preferably, the refractive index of the material forming the layers 760a, 760b is 0.05 or more, or 0.10 or less than the refractive index of the material forming the waveguides 670, 680, 690. Advantageously, the lower refractive index layers 760a, 760b may function as cladding layers that facilitate total internal reflection (TIR) of light through the waveguides 670, 680, 690 (e.g., TIR between the top and bottom major surfaces of each waveguide). In some implementations, the layers 760a, 760b are formed of air. While not illustrated, it will be appreciated that the top and bottom of the illustrated set 660 of waveguides may include immediately neighboring cladding layers.

Preferably, for ease of manufacturing and other considerations, the material forming the waveguides 670, 680, 690 are similar or the same, and the material forming the layers 760a, 760b are similar or the same. In some implementations, the material forming the waveguides 670, 680, 690 may be different between one or more waveguides, and/or the material forming the layers 760a, 760b may be different, while still holding to the various refractive index relationships noted above.

With continued reference to FIG. 9A, light rays 770, 780, 790 are incident on the set 660 of waveguides. It will be appreciated that the light rays 770, 780, 790 may be injected into the waveguides 670, 680, 690 by one or more image injection devices 360, 370, 380, 390, 400 (FIG. 6).

In some implementations, the light rays 770, 780, 790 have different properties, e.g., different wavelengths or different ranges of wavelengths, which may correspond to different colors. The in-coupling optical elements 700, 710, 720 each deflect the incident light such that the light propagates through a respective one of the waveguides 670, 680, 690 by TIR. In some implementations, the in-coupling optical elements 700, 710, 720 each selectively deflect one or more particular wavelengths of light, while transmitting other wavelengths to an underlying waveguide and associated in-coupling optical element.

For example, in-coupling optical element 700 may be configured to deflect ray 770, which has a first wavelength or range of wavelengths, while transmitting rays 780 and 790, which have different second and third wavelengths or ranges of wavelengths, respectively. The transmitted ray 780 impinges on and is deflected by the in-coupling optical element 710, which is configured to deflect light of a second wavelength or range of wavelengths. The ray 790 is deflected by the in-coupling optical element 720, which is configured to selectively deflect light of third wavelength or range of wavelengths.

With continued reference to FIG. 9A, the deflected light rays 770, 780, 790 are deflected so that they propagate through a corresponding waveguide 670, 680, 690; that is, the in-coupling optical elements 700, 710, 720 of each waveguide deflects light into that corresponding waveguide 670, 680, 690 to in-couple light into that corresponding waveguide. The light rays 770, 780, 790 are deflected at angles that cause the light to propagate through the respective waveguide 670, 680, 690 by TIR. The light rays 770, 780, 790 propagate through the respective waveguide 670, 680, 690 by TIR until impinging on the waveguide's corresponding light distributing elements 730, 740, 750.

With reference now to FIG. 9B, a perspective view of an example of the plurality of stacked waveguides of FIG. 9A is illustrated. As noted above, the in-coupled light rays 770, 780, 790, are deflected by the in-coupling optical elements 700, 710, 720, respectively, and then propagate by TIR within the waveguides 670, 680, 690, respectively. The light rays 770, 780, 790 then impinge on the light distributing elements 730, 740, 750, respectively. The light distributing elements 730, 740, 750 deflect the light rays 770, 780, 790 so that they propagate towards the out-coupling optical elements 800, 810, 820, respectively.

In some implementations, the light distributing elements 730, 740, 750 are orthogonal pupil expanders (OPE's). In some implementations, the OPE's deflect or distribute light to the out-coupling optical elements 800, 810, 820 and, in some implementations, may also increase the beam or spot size of this light as it propagates to the out-coupling optical elements. In some implementations, the light distributing elements 730, 740, 750 may be omitted and the in-coupling optical elements 700, 710, 720 may be configured to deflect light directly to the out-coupling optical elements 800, 810, 820. For example, with reference to FIG. 9A, the light distributing elements 730, 740, 750 may be replaced with out-coupling optical elements 800, 810, 820, respectively. In some implementations, the out-coupling optical elements 800, 810, 820 are exit pupils (EP's) or exit pupil expanders (EPE's) that direct light in a viewer's eye 210 (FIG. 7). It will be appreciated that the OPE's may be configured to increase the dimensions of the eye box in at least one axis and the EPE's may be to increase the eye box in an axis crossing, e.g., orthogonal to, the axis of the OPEs. For example, each OPE may be configured to redirect a portion of the light striking the OPE to an EPE of the same waveguide, while allowing the remaining portion of the light to continue to propagate down the waveguide. Upon impinging on the OPE again, another portion of the remaining light is redirected to the EPE, and the remaining portion of that portion continues to propagate further down the waveguide, and so on. Similarly, upon striking the EPE, a portion of the impinging light is directed out of the waveguide towards the user, and a remaining portion of that light continues to propagate through the waveguide until it strikes the EP again, at which time another portion of the impinging light is directed out of the waveguide, and so on. Consequently, a single beam of in-coupled light may be “replicated” each time a portion of that light is redirected by an OPE or EPE, thereby forming a field of cloned beams of light, as shown in FIG. 6. In some implementations, the OPE and/or EPE may be configured to modify a size of the beams of light.

Accordingly, with reference to FIGS. 9A and 9B, in some implementations, the set 660 of waveguides includes waveguides 670, 680, 690; in-coupling optical elements 700, 710, 720; light distributing elements (e.g., OPE's) 730, 740, 750; and out-coupling optical elements (e.g., EP's) 800, 810, 820 for each component color. The waveguides 670, 680, 690 may be stacked with an air gap/cladding layer between each one. The in-coupling optical elements 700, 710, 720 redirect or deflect incident light (with different in-coupling optical elements receiving light of different wavelengths) into its waveguide. The light then propagates at an angle which will result in TIR within the respective waveguide 670, 680, 690. In the example shown, light ray 770 (e.g., blue light) is deflected by the first in-coupling optical element 700, and then continues to bounce down the waveguide, interacting with the light distributing element (e.g., OPE's) 730 and then the out-coupling optical element (e.g., EPs) 800, in a manner described earlier. The light rays 780 and 790 (e.g., green and red light, respectively) will pass through the waveguide 670, with light ray 780 impinging on and being deflected by in-coupling optical element 710. The light ray 780 then bounces down the waveguide 680 via TIR, proceeding on to its light distributing element (e.g., OPEs) 740 and then the out-coupling optical element (e.g., EP's) 810. Finally, light ray 790 (e.g., red light) passes through the waveguide 690 to impinge on the light in-coupling optical elements 720 of the waveguide 690. The light in-coupling optical elements 720 deflect the light ray 790 such that the light ray propagates to light distributing element (e.g., OPEs) 750 by TIR, and then to the out-coupling optical element (e.g., EPs) 820 by TIR. The out-coupling optical element 820 then finally out-couples the light ray 790 to the viewer, who also receives the out-coupled light from the other waveguides 670, 680.

FIG. 9C illustrates a top-down plan view of an example of the plurality of stacked waveguides of FIGS. 9A and 9B. As illustrated, the waveguides 670, 680, 690, along with each waveguide's associated light distributing element 730, 740, 750 and associated out-coupling optical element 800, 810, 820, may be vertically aligned. However, as discussed herein, the in-coupling optical elements 700, 710, 720 are not vertically aligned; rather, the in-coupling optical elements are preferably non-overlapping (e.g., laterally spaced apart as seen in the top-down view). As discussed further herein, this non-overlapping spatial arrangement facilitates the injection of light from different resources into different waveguides on a one-to-one basis, thereby allowing a specific light source to be uniquely coupled to a specific waveguide. In some implementations, arrangements including non-overlapping spatially-separated in-coupling optical elements may be referred to as a shifted pupil system, and the in-coupling optical elements within these arrangements may correspond to sub pupils.

### Example Waveguide Having Surface Features Along Periphery

As described above, the AR or VR display may include a plurality of layers, for example, a stack of waveguides with different waveguides for different color light and/or depth planes. These waveguides may be cut from a sheet of material using a laser beam such as a UV laser beam. However, during the fabrication process some of the laser light used for cutting may be inadvertently coupled into the waveguide being cut from the sheet. Unfortunately, this UV light coupled into the waveguide may degrade the optical properties of the waveguide. Accordingly, decreasing the amount of UV light that is coupled into the waveguide during fabrication, or more specifically during singulation, may reduce the optical degradation to the waveguide caused by the UV light.

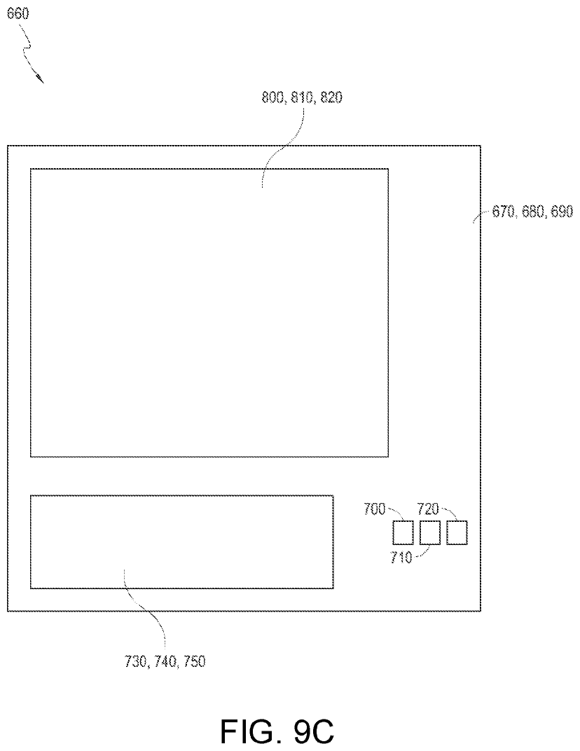

FIG. 10 shows an example waveguide 1000. The waveguide 1000 includes an in-coupling optical element 1002 configured to couple light possibly from a projector including, e.g., an LCD display, into the waveguide. The in-coupling optical element 1002 may include, for example, a diffraction grating or diffractive or holographic optical element. The waveguide 1000 further includes an out-coupling optical element 1004 configured to couple light guided within the waveguide by total internal reflection out of the waveguide toward the eye for presenting image content thereto. The out-coupling optical element 1004 may also include, for example, a diffraction grating or diffractive or holographic optical element. In some implementations, the out-coupling grating expands the light beam exiting the waveguide in multiple directions so as to increase the area over which light exits the waveguides. Such an arrangement may, for example, allow for different pupil positions due to different interpupillary distances of the user's eyes, different eye positions relative to the eyewear, etc. In some implementations, the out-coupling optical element 1004 includes a compound pupil expander (CPE).

As shown in FIG. 10, the waveguide 1000 has a main region 1006 and a peripheral region 1008 surrounding the main region. Moreover, various designs disclosed herein include a plurality of surface 1010 features disposed with in the peripheral region 1008 configured to couple light propagating in said waveguide 1000 out of said waveguide out from said peripheral region. In the design shown in FIG. 10, the plurality of surfaces features 1010 extend about the perimeter of the waveguide 1000 on each side, although the designs need not be so limited.

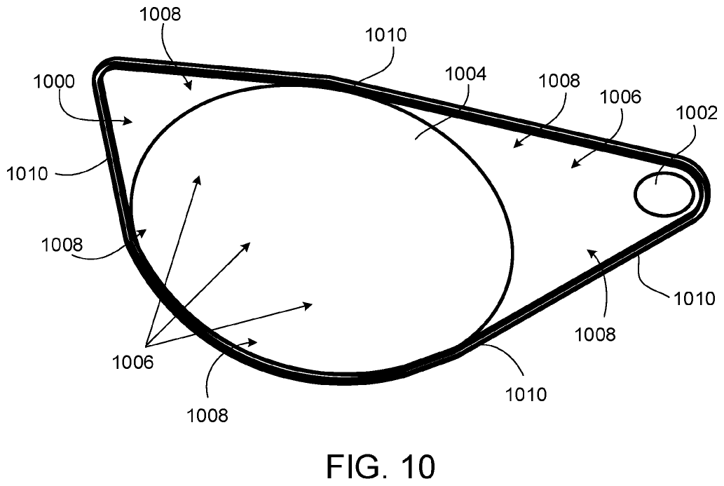

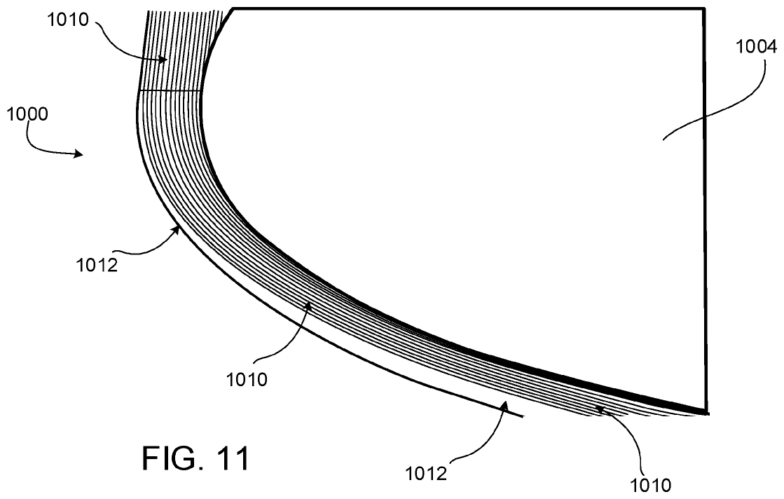

FIGS. 11 and 12 show close-up perspective views of the waveguide 1000 and the plurality of surface features 1010 in the peripheral region 1008 of the waveguide. As illustrated, the waveguide 1000 includes an edge 1012 and the plurality of surface features 1010 extend from said edge to within a distance from the edge. This distance may, for example, be smaller than the shortest distance from the edge 1012 to the out-coupling optical element 1004. Similarly, this distance may, for example, be smaller than the shortest distance from the edge 1012 to the in-coupling optical element 1002. In some implementations, the plurality of surface features 1010 extend from said edge 1012 to within 0.01 to 0.5 mm from said edge. In various implementations, the plurality of surface features 1010 extend from said edge 1012 to within 0.01 mm, 0.02 mm, 0.03 mm, 0.04 mm, 0.05 mm, 0.06 mm, 0.07 mm, 0.08 mm, 0.09 mm, 0.10 mm, 0.11 mm, 0.12 mm, 0.13 mm, 0.14 mm, 0.15 mm, 0.16 mm, 0.17 mm, 0.18 mm, 0.19 mm, 0.2 mm, 0.3 mm, 0.4 mm, 0.5 mm from said edge or any range between any of these values or possibly a longer or shorter distance.

In some implementations, the plurality of surface features 1010 extend out from said edge 1012 within 1.0 mm to 3.0 mm from said edge. In various implementations, the plurality of surface features 1010 extend out from said edge 1012 no more than 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm from said edge or any range between any of these values or possibly a longer or shorter distance. Likewise, in some implementations, the width of the plurality of said plurality of surface features may be between 1.0 mm and 3.0 mm. In various implementations, the width of said plurality of surface features 1010 may be, for example, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, or any range between any of these values or possibly a wider or smaller in width. Although 18-20 surface features are shown, for example in FIG. 12, the number of surface features may be greater or less. The number of surface features need not be constant at different locations around the waveguide 1000 but instead may vary in number. Similarly, the width of the plurality of surface features 1010 need not be constant but instead may vary. Additionally, although the plurality of surface features 1010 starts at the edge 1012 of the waveguide 1000, the plurality of surface features need not start at the edge of the waveguide but may start at a distance from the edge. This distance from the edge 1012 need not be constant at different locations around the waveguide 1000.

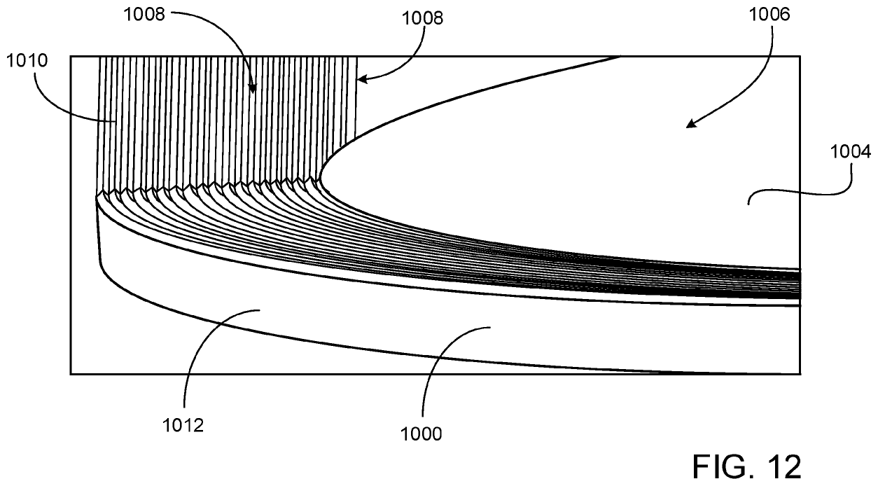

FIG. 13 is a cross-sectional view of the waveguide 1000 and the plurality of surface features 1010. As shown, the waveguide 1000 incudes top and bottom major surfaces 1014, 1016 with the edge 1012 of the waveguide extending therebetween. The waveguide 1000 may include optically transmissive or transparent material such as polymer or plastic and may potentially include glass. Light injected into the waveguide 1000 such that the light is incident on the top and bottom major surfaces 1014, 1016 as angles greater (e.g., with respect to the normal to the top and/or bottom surface) than the critical angle will reflect via total internal reflection off the top and/or bottom major surfaces and thereby be guided in the waveguide. Likewise, light coupled through the edge 1012 such as illustrated in FIG. 13 as a ray of light 1018 directed at 60° with respect to the normal to the top and/or bottom major surfaces 1014, 1016 would otherwise be guided within the waveguide 1000 by total internal reflection from the top and/or bottom major surfaces 1014, 1016. FIG. 13, however, shows this ray of light 1018 being coupled out of the waveguide 1000 by the plurality of surface features 1010 in the peripheral region 1008 of the waveguide. Thus, in the implementation shown in FIG. 13, UV light exits the top major surface 1014 at the location of surface features 1010.

In the examples shown in FIGS. 12 and 13, the plurality of surface features 1010 include sloping surfaces or sidewalls side walls 1020, 1022. In FIG. 12, the sloping surfaces or sidewalls for a given surface features have the same inclination or slope. In FIG. 13, however, sloping surfaces or sidewalls for a given surface features do not have the same inclination or slope. One of the sloping surfaces 1020 has a steeper slope than the other sloping surface 1022, which has a less steep or shallower slope. In both FIGS. 12 and 13, however, the surface features 1010 have a triangular cross-section, for example, in a direction orthogonal to the portion of the edge 1012 closest to the point of measurement. Accordingly, in various implementations, the surface features 1010 have two sloping surfaces, however, in some implementations, the surface features have only one sloping surface. Similarly, in various implementations, the surface features (e.g., their cross-section) are symmetric, while in other implementations, the surface features (e.g., their cross-section orthogonal) are asymmetric. As mentioned above, these cross-sections may be measured orthogonal to the portion of the edge 1012 closest thereto or orthogonal to their length. Accordingly, in various implementation the plurality of surface features 1010 includes a sawtooth shape. In some designs, the surface features 1010 may have surfaces 1020 oriented at an angle so as not to reflect the light by total internal reflection. For example, the surface 1020 may be oriented at an angle that is less than the critical angle. Accordingly, the plurality of surface features 1010 may include prismatic features in some implementations.

In some implementations, the surface features 1010 have a peak and a base. In various implementations, the plurality of surface features 1010 have a height or an average height in a range from 5 to 600 nanometers (nm) high. For example, the height or average height can be 5, 10, 20, 30, 40, 50, 60, 70, 80, 90, 100, 150, 200, 250, 300, 350, 400, 450, 500, 600 nm or any range between any of these values or greater or less. In some implementations, for example, the height or average height may be from 5 to 600 nm, from 5 to 700 nm, from 5 to 500 nm, from 5 to 300 nm, from 10 to 700 nm, from 10 to 500 nm, from 10 to 400 nm, from 10 to 300 nm, or any range between any of these values or larger or smaller. In some implementations, the plurality of surface features 1010 have a peak-to-peak spacing or an average peak-to-peak spacing (P) in a range from 100 to 500 nm. For example, the peak-to-peak spacing or average peak-to-peak spacing can be 50, 100, 110, 120, 130, 140, 150, 160, 170, 180, 190, 200, 250, 300, 350, 400, 450, 500, 550, 600, 650, 700 nm or any range between any of these values or greater or less. In some implementations, for example, the plurality of surface features 1010 can have a peak-to-peak spacing or an average peak-to-peak spacing in a range from 50 to 700, nm from 50 to 500 nm, from 50 to 300 nm, from 100 to 700 nm, from 100 to 600 nm, from 100 to 400, nm from 100 to 300 nm, or any range between any of these values. Similarly, in some implementations, the plurality of surface features 1010 have a full width at half maximum (FWHM) or an average full width at half maximum (FWHM) in a range from 75 to 250 nm. In some implementations, the full width at half maximum (FWHM) or average full width at half maximum (FWHM) can be 50, 60, 75, 85, 95, 100, 110, 120, 130, 140, 150, 160, 170, 180, 190, 200, 210, 220, 230, 240, 250, 300, 350, 400 nm or any range between any of these values or greater or less. In some implementations, for example, the plurality of surface features 1010 have a full width at half maximum (FWHM) or an average full width at half maximum (FWHM) in a range, from 50 to 400 nm, from 50 to 300 nm, from 50 to 200 nm, from 50 to 100 nm, from 75 to 400 nm, from 75 to 400, nm from 75 to 300 nm, from 75 to 200 nm, from 75 to 100 nm, or any range between any of these values.

The plurality of surface features may include a diffraction grating or diffractive optical element or holographic optical element. For example, the plurality of surface features may have a dimension (e.g., width, spacing, etc.) configured to diffract the desired wavelength of light such as UV light or possibly visible light. In some implementations, the diffraction grating includes a blazed grating.

In the example shown in FIG. 13, the plurality of surface features 1010 are disposed on both the top and bottom major surfaces 1014, 1016 of the waveguide 1000. In some implementations, the plurality of surface features 1010 may have the same shape, size, spacing, arrangement of shape, size, spacing or other characteristic(s), or any combination of these, on both the top and bottom major surfaces 1014, 1016. However, in other designs the one or more parameters, such as shape, size, spacing, arrangement of shape, size, spacing or other characteristic(s), or any combination of these, may be different on the top and on the bottom major surface 1014, 1016. In some implementations, however, the plurality of surface features 1010 are included on only one of the top major surface 1014 or the bottom major surface 1016.

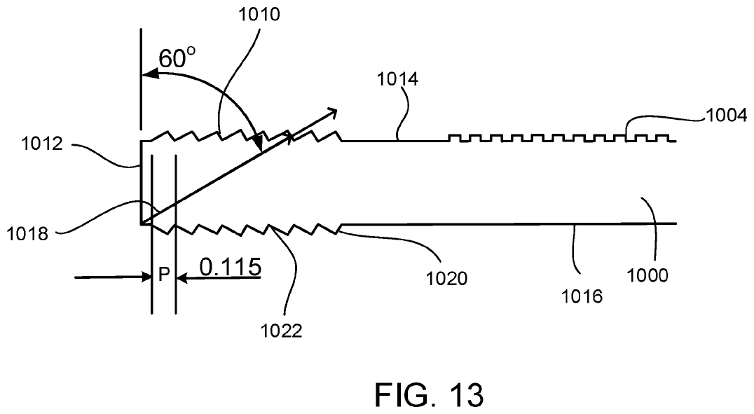

As discussed above, in some designs, the surface features 1010 may have surfaces 1020 oriented at an angle so as not to reflect the light by total internal reflection. For example, the surface 1020 may be oriented at an angle that is less than the critical angle. FIGS. 14A-14C, for example, depict light coupled through the edge 1012 of the waveguide at different angles and corresponding surface features 1010 configured to permit at least a portion of said light to exit of the waveguide. FIGS. 14A-14C, for example, respectively, show rays of light 1018a, 1018b, and 1018c directed at 45°, 60°, and 70°, with respect to the normal to the top and/or bottom major surfaces 1014, 1016 that would otherwise be guided within the waveguide 1000 by total internal reflection from the top and/or bottom major surfaces 1014, 1016 being coupled out of the waveguide by the plurality of surface features 1010 in the peripheral region 1008 of the waveguide. The surface features 1010 for the respective waveguides 1000 shown in FIGS. 14A-14C are each configured differently to couple out the respective rays of light 1018a, 1018b, and 1018c shown coupled therein. For example, in FIG. 14A, the plurality of surface features 1010 are configured to couple rays of light 1018a directed at 45° out of the waveguide. Thus, UV light can exit through perpendicular gratings at 45°. In FIG. 14B, the plurality of surface features 1010 are configured to couple rays of light 1018b directed at 60° out of the waveguide. Thus, UV light can exit through perpendicular gratings at 60°. In FIG. 14C, the plurality of surface features 1010 are configured to couple rays of light 1018b directed at 75° out of the waveguide. Thus, UV light can exit through perpendicular gratings at 75°. Accordingly, the surface features 1010 in each of three examples are configured differently. For example, the sloping surface 1020 of the surface features 1010 are oriented differently. In particular, the surface 1020 may be oriented at an angle that is less than the critical angle with respect to the incident light ray 1018. In some implementations, for example, the sloping surface 1020 to which the ray of light 1018 is incident on, may be orthogonal to the ray of light incident thereon. The sloping surface 1020 in FIG. 14A, for example, may be oriented at 45° with respect to the top and/or bottom major surfaces 1014, 1016 so as to reduce reflection of the light ray 1018a directed at 45°. Similarly, the sloping surface 1020 in FIG. 14B, for example, may be oriented at 60° with respect to the top and/or bottom major surfaces 1014, 1016 so as to reduce reflection of the light ray 1018b directed at 60°. Likewise, the sloping surface 1020 in FIG. 14C, for example, may be oriented at 70° with respect to the top and/or bottom major surfaces 1014, 1016 so as to reduce reflection of the light ray 1018c directed at 70°. With the respective ray of light 1018a, 1018b, 1018c incident on the sloping surface 1020 of the surface feature 1010 at normal incidence or in a direction orthogonal to the sloping surface, reflection is reduced such that at least of portion of this light exits through the plurality of surface features out from the waveguide 1000. The sloping surface 1020, however, need not be orthogonal to the incident light ray or rays for the light to exit the waveguide 1000.

FIG. 14D shows a ray of light 1018d at an angle so as not to be incident on the plurality of surface features 1010. In this example, the ray of light 1018d is directed at 80° with respect to the normal to the top and/or bottom major surfaces 1014, 1016. Because this angle so shallow, the light will miss the plurality of surface features 1010 and not be incident thereon. As a result, this light will be guided within the waveguide 1000 by total internal reflection from the top and/or bottom major surfaces 1014, 1016 without being coupled out of the waveguide by the plurality of surface features 1010 in the peripheral region 1008 of the waveguide. In this case, the UV light reaches too far to filter.

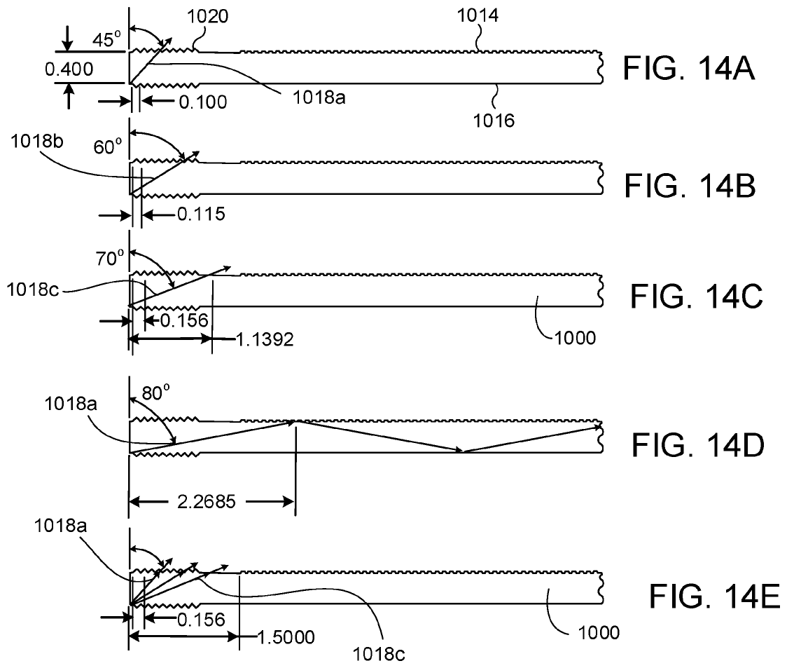

In some implementations, the plurality of surface features 1010 include surface features having different shape. For example, the plurality of surface feature 1010 may include surface features having sloping surfaces 1020 oriented at different angles. In certain implementations, such as the one shown in FIGS. 14E and 15, for example, the surface features 1010 farther from the edge 1012 have sloping surfaces 1020 that are steeper further from the edges. The example shown in FIGS. 14E and 15, for instance, includes surface features oriented at 45°, 60°, and 70° with respect to the top and bottom major surfaces 1014, 1016. The surface features 1010 oriented at 45° are closer to the edge 1012 of the waveguide 1000 closest thereto. By contrast, the surface features 1010 oriented at 70° are farther from the edge 1012 of the waveguide 1000 closest thereto. The surface features 1010 oriented at 60° are between the surface features oriented at 45° and the surface features oriented at 70°. In this manner, surface features 1010 form a composite exit grating.

Accordingly, in various implementations, the surface features 1010 have one or more parameters that changes possibly progressively, with distance from the edge 1012. For example, the surface features 1010 may have one or more parameters that increase, e.g., progressively increase, with distance from the edge 1012. Alternatively, the surface features 1010 may have one or more parameter that decrease, e.g., progressively decrease, with distance from the edge 1012. In some implementations, the surface features 1010 have one or more parameter that increases and decreases, e.g., progressively increases and decreases, with distance from the edge 1012. In some implementations, the parameter may be steepness of one of the surfaces 1020 on the same side of the surface feature, for example, side farthest from the edge 1012 closest thereto or alternatively, the side closest to the edge closest thereto. Other parameters are possible. For example, the pitch or peak to peak spacing of the surface features can change (e.g., increase or decrease) with distance from the edge. Additionally, the parameter that changes (e.g., increase or decrease) with distance from the edge may be height of the surface features. For example, for the prismatic features and gratings including prismatic features, increasing height could potentially be a more efficient at producing egress of light from the waveguide. In some implementations, the variation need not be progressive. In some implementations, the variation may change directions one or more times. In certain implementations, the variation may be progressive for short distances but change directions one or more times although the variation need not be progressive.

As discussed above, the light coupled into the edge 1012 of the waveguide 1000 as represented by the rays shown 1018a, 1018b, 1018c, 1018d may include laser light that is used to cut the waveguide from a sheet of material. This laser light may include UV light. In some situations, a portion of this laser light may couple in the waveguide 1000 and degrade to one or more optical properties of the waveguide. Accordingly, the plurality of surface features 1010 that cause a portion of this light to exit the waveguide 1000 in the peripheral region 1008 of the waveguide may in some cases advantageously reduce the amount of degradation to the main region 1006 of the waveguide. Such optical degradation may possibly include, for example increased haze and discoloration. Intense light may result in added heat and damage to the waveguide and the material including the waveguide. Increased haze may be partially caused by vaporized material depositing back on the waveguide. Such haze may cause reduced optical transmission. Discoloration such as yellowing may be caused by heating the waveguide. Similarly, UV light, e.g., excessive UV light, may cause polymer waveguide to turn yellow.

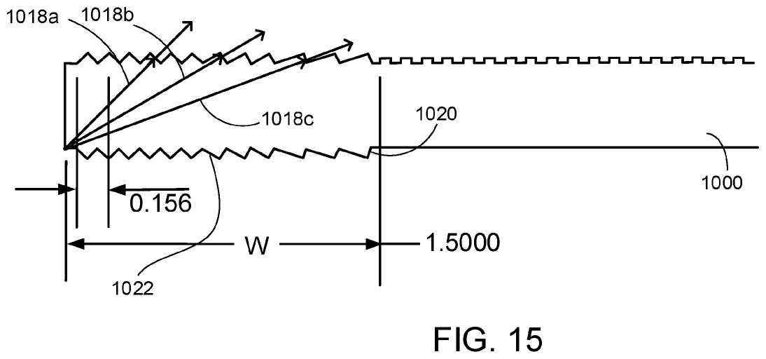

Accordingly, a method is disclosed herein directed to providing a plurality of surface features to redirect light such as UV light coupled into the waveguide during the segmentation process out of the waveguide. A flow diagram for an example method is shown in FIG. 16. In block 1021 of the flow chart, a substrate is provided having a plurality of surface features. The plurality of surface features may be included along what will be the perimeter or edge of the waveguide after segmentation using for example a laser beam to cut the waveguide from a sheet of material such as polymer or plastic. Accordingly, in block 1021 a laser beam is used to cut out an optical element such as a waveguide from the substrate by cutting along a path contacting and/or proximal to the plurality of surface features. In this manner, a layer for an eyepiece may be fabricated. The resultant layer includes a plurality surface feature disposed around the peripheral region of the layer such as shown in FIG. 10.

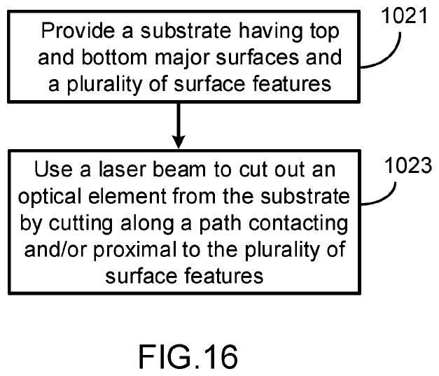

In some cases, the plurality of surface features 1010 may be configured to address light propagating from a projector that is intended to be coupled out of waveguide 1000 by the out-coupling optical element 1004 to the eye but that fails to be directed out of the waveguide by the out-coupling optical element. FIG. 17, for example depicts such an instance where light 1024 containing image content from, for example, a projector (not shown), is guided within the waveguide 1000 by reflecting one or more times from the top and/or bottom major surfaces 1014, 1016 of the waveguide. In various implementations, this light 1024 is visible light. This light 1024 or a portion thereof may be incident on the out-coupling optical element 1004. In the example of FIG. 17, an incident ray of light is shown at 60°. Out-coupling element 1004 includes can include a diffractive grating. As illustrated, a portion 1026 of this light that is incident on the out-coupling optical element 1004 is directed out of the waveguide 1000 toward the eye (not shown) by the out-coupling optical element. Additionally, a portion 1028 of this light is not coupled out of the waveguide 1000 and continues into the peripheral region 1008 of the waveguide. This portion 1028 of the light may be incident on the plurality of surface features 1010 which cause the light to exit the waveguide 1000. Light absorbing material 1030 disposed on the peripheral region 1008 of the waveguide 1000 attenuates portion 1028 of the light and reduces the likelihood that this light will return back toward the main region 1006 of the waveguide and toward the projector. Such light that is guided within the waveguide 1000 back toward the main region 1006 and the projector may possibly cause detrimental imaging effects such as rainbows and/or other visual artifacts, etc. One of the main metrics that is negatively affected by stray light from the edge of the eyepiece is diminished contrast. With augmented reality display, the intended dark areas of the image are desired to appear as dark, while bright areas are desired to appear as bright. Contrast can be metric for how effectively this goal is achieved. Stray light, for example, can make the dark areas less dark.

In various implementations, the light absorbing material 1030 includes material that substantially absorbs visible light. In some implementations, carbon black and/or dye such as black die may be used and may include the light absorbing material 1030. For example, carbon black or dye (e.g., black dye) may be mixed with liquid polymer resin or industrial adhesive, which is UV cured to become solid. In other implementations the carbon black or dye (e.g., black dye) is mixed with an evaporative solvent. Both are applied together, but in various implementations, primarily or only the carbon black remains on the edge of waveguide. This light absorbing material 1030 may be coated or deposited on the plurality of surface features. In some implementations, the light absorbing material 1030 may be conformally disposed over the plurality of surface features. The light absorbing material 1030 may be directly on the plurality of surface features or one or more layers of material may be between the light absorbing material and the surface features. The light absorbing material may be dark or black or grey or opaque or any combination of these. In some implementations, a seal is employed. Other types of opaque and/or absorbing structures such as sleeve, sheath, shield, or baffles or any combination of these may be used to reduce reflection of light back into the waveguide 1000 and/or output of light to through the peripheral region that might be visible to the user or another person looking at the user or the eyewear.

In some designs, the plurality of surface features may be configured to couple out light containing image content intended for delivery to the user's eye that is not ejected by the out-coupling optical element 1004 as well as couple light out of the waveguide that is injected into the waveguide when the waveguide is cut from a sheet of material. Accordingly, in various designs, the plurality of surface features 1010 may be configured to couple light propagating in the waveguide 1000 from said main region 1006 toward the peripheral region 1008 out of the waveguide out from said peripheral region and to couple light propagating in the waveguide from said edge 1012 toward said main region out of said waveguide out from said peripheral region.

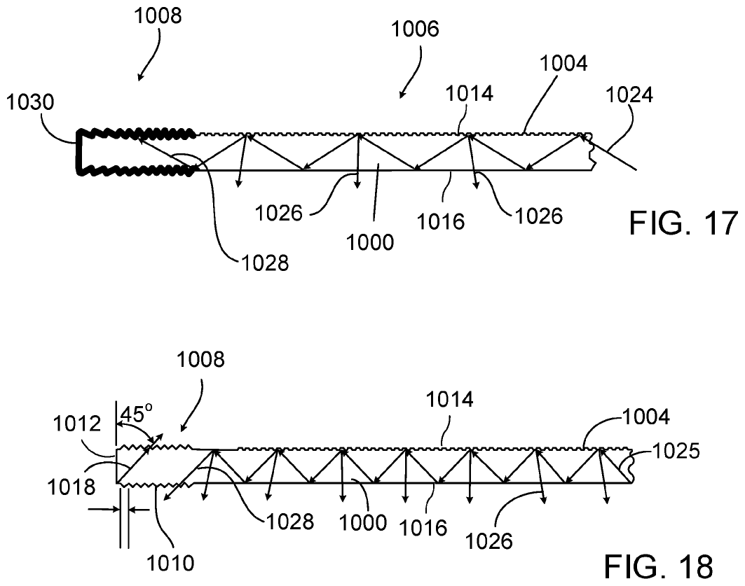

FIG. 18 shows an example waveguide 1000 including a plurality of surface features configured to couple light injected into the waveguide from the edge during the fabrication process (e.g., wherein the waveguide is cut from a sheet of material) as well as to couple light containing image content that is not redirected out of the waveguide to the eye by the out-coupling optical element out of the waveguide from the peripheral region 1008. A portion 1026 of the light is directed out of the waveguide 1000 by the out-coupling element. In this example, some UV light and some visible light exit via a 45° grating. The plurality of surfaces 1010 in this example includes sloping sides or sidewalls that are angled 45° with respect to the top and/or bottom major surfaces 1014, 1016 of the waveguide. The plurality of surface features 1010 are shown coupling light 1018, 1028 from both directions directed at an angle of 45° with respect to the top and bottom major surfaces 1014, 1016. Light from other angles may also be out-coupled by the plurality of surface features 1010. As illustrated, these surface features 1010 are triangle in the cross-section orthogonal to the edge closest thereto. Other configurations are possible, however. As described above the surface features 1010 may include diffractive features, refractive features, prismatic features or any combination thereof or may be otherwise configured. As shown, in the example shown in FIG. 18, the plurality of surface features 1010 do not include a light absorbing material disposed thereon such as shown in FIG. 17. A wide variety of other configurations, however, are possible.

It is contemplated that various implementations may be implemented in or associated with a variety of applications such as waveguides, wave guide plates, other optical elements as well as imaging systems and devices, display systems and devices, etc. The structures, devices and methods described herein may particularly find use in displays such as wearable displays (e.g., head mounted displays) that may be used for augmented and/or virtually reality. More generally, the described implementations may be implemented in any device, apparatus, or system that may be configured to display an image, whether in motion (such as video) or stationary (such as still images), and whether textual, graphical or pictorial. It is contemplated, however, that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, head mounted displays and a variety of imaging systems. Thus, the teachings are not intended to be limited to the implementations depicted solely in the Figures, but instead have wide applicability as will be readily apparent to one having ordinary skill in the art.

Various modifications to the implementations described in this disclosure may be readily apparent to those skilled in the art, and the generic principles defined herein may be applied to other implementations without departing from the spirit or scope of this disclosure. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. All such modifications are intended to be within the scope of claims associated with this disclosure.

The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower”, “above” and “below”, etc., are sometimes used for ease of describing the figures, and indicate relative positions corresponding to the orientation of the figure on a properly oriented page, and may not reflect the orientation of the structures described herein, as those structures are implemented.

Various terms are used interchangeably within this description. Each of the terms are intended to have their customary ordinarily understood plain meaning in addition to the meanings described throughout this application. For example, the terms “recording beam”, “recording light beam”, and “recording beam of light” can be used interchangeably. Similarly, the terms “head mounted display” and “wearable display” can be used interchangeably. The terms “visible spectrum” or “visible wavelength range” may refer to wavelengths visible to human eye (generally between 450 nanometers and 750 nanometers). The terms “infrared or IR spectrum” or “infrared or IR wavelength range” may refer to wavelengths used for IR imaging, thermal imaging, eye tracking, range finding and the like. IR wavelength range may include near IR wavelength range (generally between 750 nanometers to 2000 nanometers) and mid-IR wavelength range (generally between 200 nanometers to 6000 nanometers).

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

Implementations include methods that may be performed using the subject devices. The methods may include the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

In addition, while the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element-irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

1. A method of forming a waveguide for an eyepiece for a display system, said method comprising:
providing a substrate having top and bottom major surfaces and a plurality of surface features; and
using a laser beam to cut out a waveguide from said substrate by cutting along a path contacting and/or proximal to said plurality of surface features, said waveguide having edges formed by said laser beam and a main region and a peripheral region surrounding said main region, said peripheral region surrounded by said edges.

2. The method of claim 1, further comprising forming said plurality of surface features in said substrate.

3. The method of claim 1, further comprising forming said plurality of surface features in said substrate using nano-imprinting.

4. The method of claim 1, wherein the plurality of surface features is configured such that at least some of said laser light that is coupled into said waveguide is directed out of said waveguide by said plurality of surface features.

5. The method of claim 1, wherein the plurality of surface features comprises a diffraction grating.

6. The method of claim 1, wherein the plurality of surface features comprises a blazed grating.

7. The method of claim 1, wherein a plurality of said surface features have at least one sloping surface.

8. The method of claim 1, wherein a plurality of said surface features have two sloping surfaces.

9. The method of claim 1, wherein a plurality of said surface features have a sawtooth shape.

10. The method of claim 1, wherein a plurality of said surface features have a triangular cross-section.

11. The method of claim 1, wherein a plurality of surface features are asymmetric.

12. The method of claim 1, wherein a plurality of surface features are symmetric.

13. The method of claim 1, wherein the plurality of surface features have an average height in a range from 10 to 500 nanometers high.

14. The method of claim 1, wherein the plurality of surface features have an average peak-to-peak spacing in a range from 100 to 500.

15. The method of claim 1, wherein the plurality of surface features have an average full width at half maximum (FWHM) in a range from 75 to 250 nm.

16. The method of claim 1, wherein the substrate is cut by the laser such that the plurality of surface features extends out, on one or both of the top and bottom major surfaces no more than 2 mm from the path cut by the laser.

17. The method of claim 1, wherein the substrate is cut by the laser such that the plurality of surface features extends out, on one or both of the top and bottom major surfaces no more than 1.8 mm from the path cut by the laser.

18. The method of claim 1, wherein the substrate is cut by the laser such that the plurality of surface features extends out, on one or both of the top and bottom major surfaces no more than 1.6 mm from the path cut by the laser.

19. The method of claim 1, wherein the substrate is cut by the laser such that the plurality of surface features extends to at least within 0.2 mm from said path cut by the laser.

20. The method of claim 1, wherein the substrate is cut by the laser such that the plurality of surface features extends to at least within 0.1 mm from said path cut by the laser.

21. The method of claim 1, wherein the substrate is cut by the laser such that the plurality of surface features extends to at least within 0.05 mm from said path cut by the laser.

22. The method of claim 1, further comprising depositing light absorbing material on the edge and one or more of plurality of surface features.

23. The method of claim 22, further comprising covering an area beyond portions of the top and bottom major surfaces having the plurality of surface features with the light absorbing material.

24. The method of claim 1, wherein said plurality of surface features are not covered by dark material.

25. The method of claim 1, wherein said plurality of surface features are not covered by black or grey material.

26. The method of claim 1, wherein said plurality of surface features are not covered by opaque material.

27. The method of claim 1, wherein the waveguide is included as part of a stack of waveguides.

28. The method of claim 1, wherein the eyepiece is disposed on a frame configured to be supported on the head or face of the user.

29. The method of claim 1, wherein the eyepiece is included in eyewear configured to be worn by the user.

30. The method of claim 1, wherein the eyepiece is transparent such that the user can see through the eyepiece to view the environment in front of the user and the eyepiece.

31. The method of claim 1, wherein said laser beam cuts along an edge of said plurality of surface features.

32. The method of claim 1, wherein said laser beam cuts along a path surrounded on both sides by a plurality of said surface features.

33. The method of claim 1, wherein said laser beam cuts along a path surrounding said plurality of surface features such that said plurality of surface features are disposed between said path and said main region.

34. A display system configured to be disposed on a user's head and/or face so as to present images to a user's eye, said display system comprising:
at least one light source configured to produce light;
an eyepiece configured to direct light from said light source to a user's eye to display image content therein, said eyepiece comprising:
at least one waveguide having top and bottom major surfaces and an edge extending therebetween, said waveguide having a main region and a peripheral region surrounding said main region, said peripheral region more proximal to said edge than said main region, said waveguide configured to propagate light from said at least one light source between said top and bottom major surfaces by total internal reflection and eject at least some of said light out of at least a portion of said main region of said waveguide to said user's eye to present image content thereto, and a plurality of surface features within said peripheral region of said waveguide configured to couple light propagating in said waveguide out of said waveguide out from said peripheral region, said surface features having one or more parameters that changes with distance from said edge closest thereto.

35. The display system of claim 34, wherein the plurality of surface features comprises a diffractive optical element.

36. The display system of claim 34, wherein the plurality of surface features comprises a diffraction grating.

37. The display system of claim 34, wherein the plurality of surface features comprises a blazed grating.

38. The display system of claim 34, wherein at least one of said surface features has at least one sloping surface.

39. The display system of claim 34, wherein at least one of said surface features has two sloping surfaces.

40. The display system of claim 34, wherein a plurality of said surface features have a sawtooth shape.

41. The display system of claim 34, wherein a plurality of said surface features have a triangular cross-section orthogonal to the portion of the edge closest thereto.

42. The display system of claim 34, wherein a plurality of said surface features are asymmetric.

43. The display system of claim 34, wherein a plurality of said surface features are symmetric.

44. The display system of claim 34, wherein the plurality of surface features has an average height in a range from 10 to 500 nanometers high.

45. The display system of claim 34, wherein the plurality of surface features has an average peak-to-peak spacing in a range from 100 and 500 nm.

46. The display system of claim 34, wherein the plurality of surface features has an average full width at half maximum (FWHM) in a range from 75 and 250 nm.

47. The display system of claim 34, wherein the plurality of surface features extends out, on one or both of the top and bottom major surfaces no more than 2 mm from the edge.

48. The display system of claim 34, wherein the plurality of surface features extends out, on one or both of the top and bottom major surfaces no more than 1.8 mm from the edge.

49. The display system of claim 34, wherein the plurality of surface features extends out, on one or both of the top and bottom major surfaces no more than 1.6 mm from the edge.

50. The display system of claim 34, wherein the plurality of surface features extends to within 0.2 mm from said edge.

51. The display system of claim 34, wherein the plurality of surface features extends to within 0.1 mm from said edge.

52. The display system of claim 34, wherein the plurality of surface features extends to within 0.05 mm from said edge.

53. The display system of claim 34, further comprising a light absorbing material disposed on the edge and one or more of the plurality of surface features.

54. The display system of claim 53, wherein the light absorbing material covers an area beyond portions of the top and bottom major surfaces having the plurality of surface features.

55. The display system of claim 34, wherein said plurality of surface features are not covered by dark material.

56. The display system of claim 34, wherein said plurality of surface features are not covered by black or grey material.

57. The display system of claim 34, wherein said plurality of surface features are not covered by opaque material.

58. The display system of claim 34, wherein the waveguide is part of a stack of waveguides.

59. The display system of claim 34, wherein the eyepiece is disposed on a frame configured to be supported on the head or face of the user.

60. The display system of claim 34, wherein the eyepiece forms part of eyewear configured to be worn by the user.

61. The display system of claim 34, wherein the eyepiece is transparent such that the user can see through the eyepiece to view the environment in front of the user and the eyepiece.

62. (canceled)

63. (canceled)

64. (canceled)

65. (canceled)

66. The display system of claim 34, wherein said surface features have a surface oriented at an angle and said one or more parameters comprises the angle of orientation of said surface.

67. The display system of claim 66, wherein surface features further from said edge have steeper sloping surfaces than surface features closer to said edge of said surface.

68. The display system of claim 34, wherein said one or more parameters comprises the pitch of the plurality of surface features.

69. The display system of claim 34, wherein said one or more parameters comprises the peak-to-peak spacing of the surface features.

70. The display system of claim 34, wherein said one or more parameters comprises the height of the surface features.
